(19) United States
(12) Patent Application Publication
(10) Pub. No.: US 2026/0162348 A1
(43) Pub. Date: Jun. 11, 2026

(54) VIDEO GENERATION METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Hui GUO, Shenzhen (CN)

(21) Appl. No.: 19/181,685

(22) Filed: Apr. 17, 2025

Related U.S. Application Data
(63) Continuation of application No. PCT/CN2024/073423, filed on Jan. 22, 2024.

(30) Foreign Application Priority Data
Mar. 9, 2023 (CN) 202310258853.4

(51) Int. Cl. G06T 13/80; G06T 11/00; G06V 10/30; G06V 10/44; G06V 10/74; G06V 10/762; G06V 10/80; G06V 20/40

(52) U.S. Cl. CPC G06T 13/80; G06T 11/00; G06V 10/30; G06V 10/44; G06V 10/761; G06V 10/762; G06V 10/806; G06V 20/41; G06V 20/46

(57) ABSTRACT

This application discloses a video generation method and apparatus, an electronic device, a computer-readable storage medium, and a computer program product, including: obtaining an initial image, and obtaining a plurality of pieces of description text, each piece of description text describing a frame image in a frame image sequence to be generated; iteratively generating, by using the initial image as a 1st frame image and based on the 1st frame image and the plurality of pieces of description text, at least one frame image located after the 1st frame image, to obtain a frame image sequence comprising the 1st frame image and the at least one frame image; and performing video synthesis on each frame image in the frame image sequence, to obtain a target video.

### RELATED APPLICATIONS

This application is a continuation of PCT Application No. PCT/CN2024/073423, filed on Jan. 22, 2024, which claims priority to Chinese Patent Application No. 2023102588534, filed on Mar. 9, 2023, which are both incorporated herein by reference in their entirety.

### FIELD OF THE TECHNOLOGY

This application relates to the field of computer technologies, and in particular, to a video generation method and apparatus, an electronic device, a computer-readable storage medium, and a computer program product.

### BACKGROUND OF THE DISCLOSURE

In a scene of a film or a television drama, when uploading an image, a user usually expects to animate the image through a video technology, so that the image is of the style of the film or television drama, for example, a short video clip displaying a character expression change or a scenery switch.

Consistency between an output image and an input image in this the scenario is often poor, and accuracy of image content is often poor, which lead to poor consistency and content continuity of a generated video.

### SUMMARY

Embodiments of this application provide a video generation method and apparatus, an electronic device, a computer-readable storage medium, and a computer program product, to improve accuracy of frame images in a video and consistency between adjacent frame images.

The technical solutions in the embodiments of this application are implemented as follows.

An embodiment of this application provides a video generation method, including obtaining an initial image, and obtaining a plurality of pieces of description text, each piece of description text describing a frame image in a frame image sequence to be generated; iteratively generating, by using the initial image as a 1st frame image and based on the 1st frame image and the plurality of pieces of description text, at least one frame image located after the 1st frame image, to obtain a frame image sequence comprising the 1st frame image and the at least one frame image; and performing video synthesis on each frame image in the frame image sequence, to obtain a target video.

An embodiment of this application provides an electronic device, including a memory, configured to store executable instructions; and a processor, configured to implement the video generation method provided in this embodiment of this application when executing the computer-executable instructions stored in the memory.

An embodiment of this application provides a non-transitory computer-readable storage medium, having computer-executable instructions stored therein, the computer-executable instructions, when executed by a processor, enabling the processor to perform the video generation method provided in this embodiment of this application.

In the embodiments consistent with the present disclosure, the obtained initial image is used as the 1^{st} frame image in the frame image sequence to be generated, each frame image located before the frame image, the description text associated with each frame image located before the frame image, and the description text of the frame image are fully referred to when other frame images in the frame image sequence to be generated are generated, and then the target video is generated based on each frame image in the frame image sequence. This improves both the accuracy of each video frame and the consistency between adjacent frames.

### BRIEF DESCRIPTION OF THE DRAWINGS

FIG. 1 is a schematic diagram of an architecture of a video generation system 100 according to an embodiment of this application.

FIG. 2 is a schematic diagram of the structure of an electronic device 500 implementing a video generation method according to an embodiment of this application.

FIG. 3 is a schematic flowchart of a video generation method according to an embodiment of this application.

FIG. 4 is a schematic diagram of a generation process of an i^{th} frame image according to an embodiment of this application.

FIG. 5 is a schematic diagram of a determining method for text constraint information according to an embodiment of this application.

FIG. 6 is a schematic diagram of a text feature extraction procedure based on a CLIP model according to an embodiment of this application.

FIG. 7 is a schematic diagram of a determining method for image-text constraint information according to an embodiment of this application.

FIG. 8 is a schematic diagram of an image-text feature extraction process according to an embodiment of this application.

FIG. 9 is a schematic flowchart of a frame image generation process according to an embodiment of this application.

FIG. 10 is a diagram of a generation process of an i^{th} frame image according to an embodiment of this application.

FIG. 11 shows a frame image generation method based on a machine learning model according to an embodiment of this application.

FIG. 12 is a flowchart of concatenated frame image generation models according to an embodiment of this application.

FIG. 13 is a schematic diagram of a method for training a frame image generation model according to an embodiment of this application.

FIG. 14 is a schematic diagram of a video sample processing procedure according to an embodiment of this application.

FIG. 15 is a flowchart of a clustering process for a video sample according to an embodiment of this application.

FIG. 16 is a schematic diagram of a determining process of a distance threshold according to an embodiment of this application.

FIG. 17 is another schematic flowchart of a video generation method according to an embodiment of this application.

FIG. 18A is a schematic diagram of a summarization procedure of a video generation method according to an embodiment of this application.

FIG. 18B is a visualization schematic diagram of generation of a plurality of frame images according to an embodiment of this application.

FIG. 19 is a schematic diagram of a structure of a consecutive frame generation model according to an embodiment of this application.

FIG. 20 is a schematic diagram of a standard diffusion model according to an embodiment of this application.

FIG. 21A is a schematic diagram of a process of a U-Net in which constraint information is not added according to an embodiment of this application.

FIG. 21B is a schematic diagram of a U-Net in which constraint information is added according to an embodiment of this application.

FIG. 22 is a schematic diagram of a structure of a BLIP-based text extraction model according to an embodiment of this application.

FIG. 23 is a schematic diagram of a training data collection procedure according to an embodiment of this application.

FIG. 24 is a schematic diagram of a sub-shot operation on a video sample according to an embodiment of this application.

FIG. 25 is a schematic diagram of an inference process of consecutive frame images according to an embodiment of this application.

### DESCRIPTION OF EMBODIMENTS

To make the objectives, technical solutions, and advantages of this application clearer, the following describes this application in detail with reference to the accompanying drawings. The embodiments described are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict.

In the following descriptions, the included term “first/second” is merely intended to distinguish similar objects but does not necessarily indicate a specific order of an object. “First/second” is interchangeable in terms of a specific order or sequence if permitted, so that the embodiments of this application described herein can be implemented in a sequence in addition to the sequence shown or described herein.

Unless otherwise defined, the meanings of all technical and scientific terms used in this specification are the same as those usually understood by a person skilled in the art to which this application belongs. Terms used in this specification are merely intended to describe objectives of the embodiments of this application, but are not intended to limit this application.

In the embodiments of this application, data related to attributes of a user image is involved. When the embodiments of this application are applied to products or technologies, user permission or consent needs to be obtained, and collection, use, and processing of related data need to comply with related laws, regulations, and standards of related countries and regions.

Before the embodiments of this application are described in detail, a description is made on nouns and terms involved in the embodiments of this application, and the nouns and terms involved in the embodiments of this application are applicable to the following explanations.
(1) Image recognition: recognition on a category level. Recognition is performed without considering a specific example of an object, and only a category (for example, human, a dog, a cat, or a bird) of the object is considered, and a category to which the object belongs is given. A typical example is a recognition task in a large general object recognition open-source data set imagenet, to recognize an object belonging to which category in 1000 categories.
(2) Imagenet: a large general object recognition open-source data set.
(3) Imagenet pretraining model: A deep learning network model is trained based on an imagenet, to obtain parameter weights of the model, namely, the imagenet pretraining model.
(4) Stock images of a film or television drama: All videos of the film or television drama are collected. Because the data volume of the videos of the film or television drama is huge after frame extraction is performed, data needs to be compressed, to avoid excessive long time being spent on retrieval. Therefore, the videos are divided into sub-shots, and one frame image is extracted from each sub-shot and is stored into a stock.
(5) Contrastive language-image pretraining (CLIP) model: An input of the CLIP model is a sample pair formed by images and text, and an architecture is divided into two parts: an image encoder and a text encoder. Text branch of CLIP: Each novel statement is encoded by using a text encoder (which may be transform), to obtain N text feature vectors (T1, T2, T3, . . . , and TN). Image branch of CLIP: Each stock image of a film or television drama is encoded by using the image encoder (which may be resnet), to obtain N image feature vectors (I1, I2, I3, . . . , and IN).

A feature vector matrix is constructed based on the text feature vector and the image feature vector when an image similarity and a text similarity need to be compared. Because an image and text are matched on a diagonal part of the feature vector matrix, a similarity is the greatest. Therefore, an inner product of two feature vectors on the diagonal of the matrix is obtained, and a larger inner product indicates a higher similarity.
(6) Diffusion model is an image generation model and is configured to learn information attenuation caused by noise and then generate an image by using a learned mode. The concept is also applicable to a latent variable, because the diffusion model tries to learn noise distribution rather than data distribution. The noise distribution is modeled by using a concept of a Markov chain, which makes the diffusion model a probabilistic model. The diffusion model includes two stages, a forward and diffusion process in which an original image gradually changes to noise, and a reverse process in which the noise gradually changes to the original image. Diffusion generation model: Complex real distribution is converted into simple prior distribution through gradual noise adding, and a generation model of real distribution is generated from the simple prior distribution through gradual denoising.
(7) A pure vision transformer model (ViT) is a model configured for image classification, and uses a transformer-similar structure on a patch of an image to perform a task of image classification. An inputted image is segmented into patches of a fixed size, each patch is linearly embedded, a position embedding representation (represented by using a vector) is added, which is referred to as position embedding, and an obtained vector sequence is sent to a standard Transformer encoder for learning. To perform classification, an additional learnable “classification token” is added to the sequence.

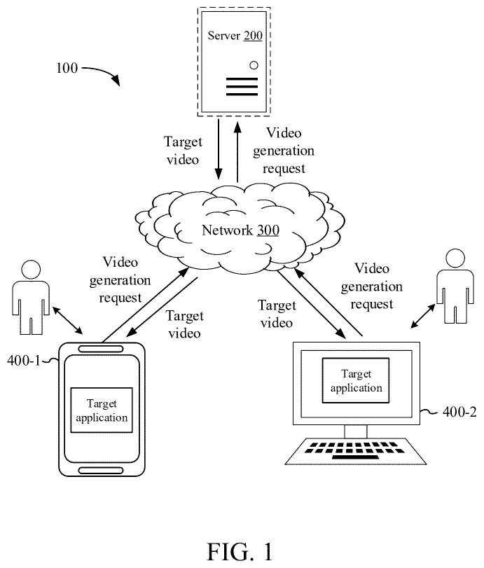

Based on the foregoing explanations of nouns and terms in the embodiments of this application, the following describes a video generation system provided in the embodiments of this application. FIG. 1 is a schematic diagram of an architecture of a video generation system 100 according to an embodiment of this application. To support an exemplary application, a terminal (for example, a terminal 400-1 and a terminal 400-2) is connected to a server 200 through a network 300. The network 300 may be a wide area network or a local area network, or a combination thereof. Data transmission is implemented by using a wireless or wired link.

In some embodiments, a target application that can implement a video generation function is deployed on the terminal (for example, the terminal 400-1 and the terminal 400-2). The target application can generate a target video having a target style (such as a film or television drama style or an animation style) according to an inputted initial image and description text of each frame image in a video to be generated. The terminal transmits a video generation request for the target video to the server based on the target application. The video generation request carries an initial image used as a 1^{st} frame image in a frame image sequence to be generated and description text of a 2^{nd} frame image in the frame image sequence to be generated. The terminal further receives the target video returned by the server, and performs a target operation on the target video. The target operation includes one or more of the following operations: playing, downloading, sharing, and the like. There are at least two items mentioned herein.

In some embodiments, the server 200 is configured to receive the video generation request for the target video that is sent by the terminal, parse the video generation request, use the obtained initial image as the 1^{st} frame image in the frame image sequence to be generated, obtain through parsing the description text of the 2^{nd} frame image in the frame image sequence to be generated, and iteratively generate, based on the 1^{st} frame image and description text of each frame image in the frame image sequence, each frame image located after the 1^{st} frame image in the frame image sequence; and perform video synthesis on each frame image in the frame image sequence, to obtain the target video.

In some embodiments, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal (such as a terminal 400-1 and a terminal 400-2) may be a smartphone, a tablet computer, a notebook computer, a desktop computer, a smart speaker, a smart watch, or the like, but is not limited thereto. Terminals (e.g., terminal 400-1 and 400-2) and server 200 can connect via wired or wireless communication, directly or indirectly, without limitations in this application.

This embodiment of this application may be further implemented with the help of a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. A backend service of a technical network system requires a large amount of computing and storage resources.

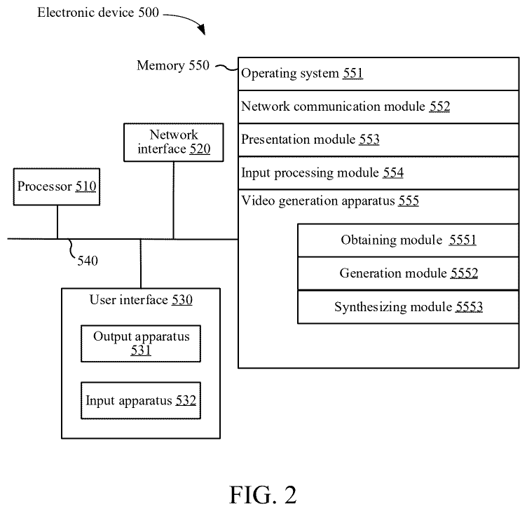

Next, an electronic device that implements the video generation method provided in the embodiment of this application is described. FIG. 2 is a schematic diagram of the structure of an electronic device 500 implementing a video generation method according to an embodiment of this application. The electronic device 500 may be the server 200 or the terminal shown in FIG. 1. That the electronic device 500 is the server shown in FIG. 1 is used as an example. An electronic device for implementing the video generation method according to an embodiment of this application is described. The electronic device 500 provided in the embodiments of this application includes: at least one processor 510, a memory 550, at least one network interface 520, and a user interface 530. All the components in the electronic device 500 are coupled together by using a bus system 540. The bus system 540 is designed to facilitate connection and communication between the components. In addition to a data bus, the bus system 540 further includes a power supply bus, a control bus, and a status signal bus. However, for ease of clear description, all types of buses in FIG. 2 are marked as the bus system 540.

The processor 510 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

In some embodiments, the user interface 530 includes one or more output apparatuses 531 that can display media content, including one or more loudspeakers and/or one or more visual display screens. The user interface 530 further includes one or more input apparatuses 532, including a user interface component helping a user input, for example, a keyboard, a mouse, a microphone, a touch display screen, a camera, or another input button and control.

The memory 550 may be a removable memory, a non-removable memory, or a combination thereof. Exemplary hardware devices include a solid-state memory, a hard disk drive, an optical disc driver, or the like. In some embodiments, the memory 550 includes one or more storage devices physically away from the processor 510.

The memory 550 includes a volatile memory or a non-volatile memory, or may include a volatile memory and a non-volatile memory. The non-volatile memory may be a read-only memory (ROM), and the volatile memory may be a random access memory (RAM). The memory 550 described in the embodiments of this application is to include any other suitable type of memories.

In some embodiments, the memory 550 can store data to support various operations, examples of the data include programs, modules, and data structures, or subsets or supersets thereof, as illustrated below.

An operating system 551 includes a system program configured to process various basic system services and perform hardware-related tasks, for example, a frame layer, a core library layer, and a driver layer, and the operating system is configured to implement various basic services and process hardware-based tasks. A network communication module 552 is configured to reach another computing device via one or more (wired or wireless) network interfaces 520. Exemplary network interfaces 520 include: Bluetooth, wireless compatibility authentication (Wi-Fi), a universal serial bus (USB), and the like. A presentation module 553 is configured to present information by using an output apparatus 531 (for example, a display screen or a speaker) associated with one or more user interfaces 530 (for example, a user interface configured to operate a peripheral device and display content and information). An input processing module 554 is configured to detect one or more user inputs or interactions from one of the one or more input apparatuses 532 and translate the detected input or interaction.

In some embodiments, the video generation apparatus provided in the embodiments of this application may be implemented by using software. FIG. 2 shows a video generation apparatus 555 stored in the memory 550. The video generation apparatus 555 may be software in a form such as a program or a plug-in, and includes the following software modules: an obtaining module 5551, a generation module 5552, and a synthesizing module 5553. These modules are logical modules, and therefore may be randomly combined or divided according to a function to be implemented, and the function of each module will be described below.

In some other embodiments, the video generation apparatus provided in the embodiments of this application may be implemented by a combination of software and hardware. For example, the video generation apparatus provided in the embodiments of this application may be a processor in a form of a hardware decoding processor, programmed to perform the video generation method provided in the embodiments of this application. For example, the processor in the form of a hardware decoding processor may use one or more application-specific integrated circuits (ASICs), a DSP, a programmable logic device (PLD), a complex programmable logic device (CPLD), a field-programmable gate array (FPGA), or other electronic components.

In some embodiments, the terminal or the server may implement the video generation method provided in the embodiments of this application by running a computer program. For example, the computer program may be a native program or a software module in an operating system; may be a native application (APP), namely, a program that needs to be installed in an operating system to run, such as an instant messaging APP and a web page browser APP; or may be a mini program, namely, a program that only needs to be downloaded into a browser environment to run; or may be a mini program that can be embedded in any APP. In summary, the computer program may be an application, a module, or a plug-in in any form. For example, a target application deployed on a terminal (for example, a terminal 400-1 and a terminal 400-2) shown in FIG. 1 may be an application, a module, or a plug-in in any of the foregoing forms. The target application can implement a video generation function. For example, the terminal may receive an initial image and description text that are uploaded based on a man-machine interaction interface provided by the target application, and output a generated target video.

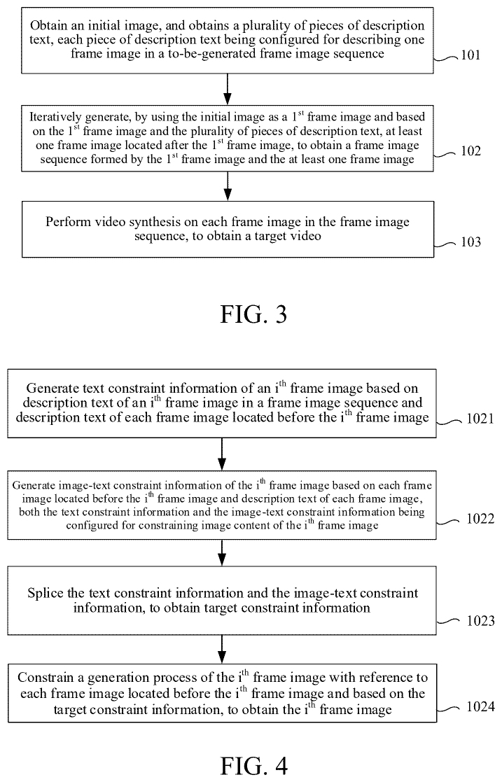

Based on the foregoing descriptions of the video generation system and the electronic device provided in the embodiments of this application, the video generation method provided in the embodiments of this application is described below. In some embodiments, the video generation method provided in the embodiments of this application may be independently implemented by a terminal or a server, or may be collaboratively implemented by a terminal and a server. An example in which the server 200 in FIG. 1 independently performs the video generation method provided in the embodiments of this application is used for description. FIG. 3 is a schematic flowchart of a video generation method according to an embodiment of this application. Descriptions are provided with reference to operations shown in FIG. 3.

Operation 101: A server obtains an initial image, and obtains a plurality of pieces of description text, each piece of description text being configured for describing one frame image in a frame image sequence to be generated.

In some embodiments, the server receives a video generation request for a video to be generated, and parses the video generation request, to obtain the initial image and description text of each frame image for the video to be generated. The video to be generated may be represented by the frame image sequence to be generated including N consecutive frame images. N is greater than or equal to a positive integer of 2, and N may be carried in the video generation request, or may be read by the server from a preset configuration file. In addition, the initial image carried in the video generation request is used as a 1^{st} frame image in the frame image sequence to be generated. To ensure consistency between the frame images in the frame image sequence to be generated, the video generation request generally may further carry preset description texts for each frame image in the frame image sequence to be generated. The description text associated with the frame image represents image content of a frame image to be generated. That is, the description text can describe the image content of the expected frame image to be generated. Certainly, in some embodiments, content of the description text may be null. That is, for each frame image in the video to be generated in the video generation request, the description text may exist in some frame images.

Operation 102: Iteratively generate, by using the initial image as a 1^{st} frame image and based on the 1^{st} frame image and the plurality of pieces of description text, at least one frame image located after the 1^{st} frame image, to obtain a frame image sequence formed by the 1^{st} frame image and the at least one frame image.

In some embodiments, the server may iteratively generate, based on the 1^{st} frame image and each piece of description text and in the following manner, each frame image located after the 1^{st} frame image in the frame image sequence: generating an i^{th} frame image based on description text of an i^{th} frame image in the frame image sequence, each frame image that is in the frame image sequence and that is located before the i^{th} frame image, and description text of each frame image located before the i^{th} frame image, i being a positive integer greater than 1, and i being less than or equal to a preset quantity; and traversing i, to obtain each frame image that is in the frame image sequence and that is located after the 1^{st} frame image.

The preset quantity may be a quantity of frame images in the frame image sequence to be generated.

In some embodiments, a generation process of the i^{th} frame image is repeatedly performed, to obtain each frame image in the frame image sequence to be generated.

In some embodiments, when the server generates the i^{th} (i is a positive integer greater than or equal to 2) frame image in the frame image sequence, to keep content consistency with the frame image located before the i^{th} frame image, the server may use each frame image located before the i^{th} frame image and the description text of each frame image located before the i^{th} frame image as constraint information when image generation is performed on the i^{th} frame image, to constrain a generation process for the i^{th} frame image, so that content of the generated i^{th} frame image is consistent with content of the frame image located before the i^{th} frame image. The content consistency may include one or more of the following: character consistency, background consistency, and scenario consistency in an image. The content consistency is usually determined by calculating a similarity between the i^{th} frame image and an (i−1)^{th} frame image for a particular content type (a character, a background, a scenario, or the like). When the similarity meets a predetermined threshold, the i^{th} frame image is deemed consistent with the (i−1)^{th} frame image.

The generation process of the i^{th} frame image is detailed below. In some embodiments, FIG. 4 is a schematic diagram of a generation process of an i^{th} frame image according to an embodiment of this application. Based on FIG. 3, operation 102 may be implemented by operation 1021 to operation 1024. Descriptions are provided with reference to operations shown in FIG. 4.

Operation 1021: A server generates text constraint information of an i^{th} frame image based on description text of an i^{th} frame image in a frame image sequence and description text of each frame image located before the i^{th} frame image.

In some embodiments, constraint information indicating that the generation process of the i^{th} frame image is constrained may include one or more of the following: text constraint information, image-text constraint information, image constraint information, and the like. The text constraint information is constraint information in a pure text mode. That is, the constraint information is described in a manner of text, to indicate that the generation process of the frame image is constrained in the manner of text description. The image constraint information is constraint information in a pure image mode. That is, the constraint information is described through an image, to indicate that the generation process of the frame image is constrained in a manner of an image. The image-text constraint information is image-text cross-mode constraint information. That is, the constraint information is described in a manner of image plus text, to indicate that the generation process of the frame image is constrained in a manner of image plus text. The server may perform feature extraction on the description text of the i^{th} frame image and the description text of each frame image located before the i^{th} frame image respectively, and generate the text constraint information based on obtained text features.

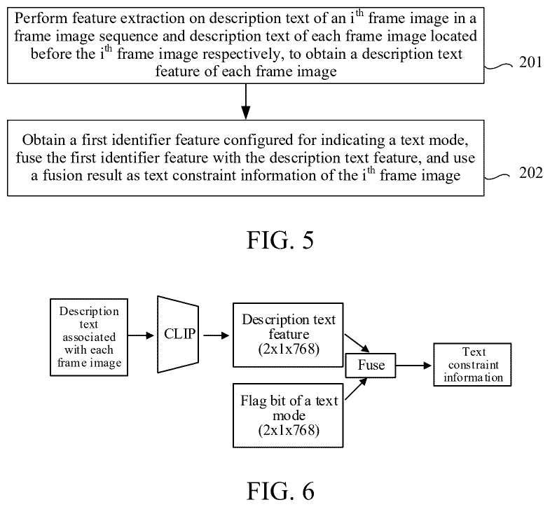

A determining manner for the text constraint information is described. In some embodiments, a determining process of the text constraint information may be independently implemented by the terminal or the server, or may be collaboratively implemented by the terminal and the server. An example in which the server 200 in FIG. 1 independently performs the foregoing determining process of the text constraint information is used for description. FIG. 5 is a schematic diagram of a method for determining text constraint information according to an embodiment of this application. Descriptions are provided with reference to operations shown in FIG. 5.

Operation 201: A server performs feature extraction on description text of an i^{th} frame image in a frame image sequence and description text of each frame image located before the i^{th} frame image respectively, to obtain a description text feature of each frame image.

In some embodiments, the server may extract the text feature of the description text of each frame image by using a machine learning model (for example, CLIP) that can perform text feature extraction. To be specific, the server performs feature extraction on the description text of each frame image located before the i^{th} frame image, to obtain a description text feature of corresponding description text, namely, a vector representation or a feature vector of the description text. The description text feature indicates a semantic feature of the description text. The CLIP model includes an image encoder and a text encoder. By using a text branch of the CLIP, the description text of each frame image is encoded by using a text encoder (which may be transform), to obtain the description text feature (which is represented by a vector during calculation) corresponding to each description text.

Operation 202: Obtain a first identifier feature configured for indicating a text mode, fuse the first identifier feature with the description text feature, and use a fusion result as text constraint information of the i^{th} frame image.

For example, FIG. 6 is a schematic diagram of a text feature extraction procedure based on a CLIP model according to an embodiment of this application. For description text associated with all frame images located before the i^{th} frame image, text features are extracted through a CLIP text branch, to obtain a 2×1×768 three-dimensional matrix, and then, the three-dimensional matrix is fused with a flag bit (2×1×768) representing a pure text mode, to obtain text constraint information of the i^{th} frame image.

Operation 1022: Generate image-text constraint information of an i^{th} frame image based on each frame image located before the i^{th} frame image and description text of each frame image, both text constraint information and image-text constraint information being configured for constraining image content of the i^{th} frame image.

In some embodiments, the server may perform image feature extraction on each frame image located before the i^{th} frame image, to obtain a corresponding image feature, and perform text feature extraction on the description text of each frame image located before the i^{th} frame image, to obtain a corresponding text feature. Then, a fusion operation is performed on the text feature and the image feature, to obtain the image-text constraint information of the i^{th} frame image.

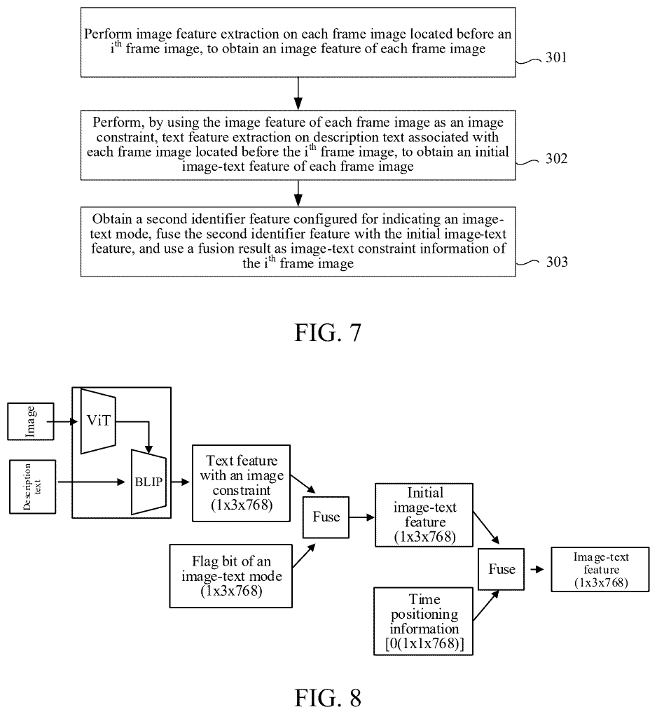

A method for determining the image-text constraint information is described. In some embodiments, a determining process of the image-text constraint information may be independently implemented by the terminal or the server, or may be collaboratively implemented by the terminal and the server. An example in which the server 200 in FIG. 1 independently performs the foregoing determining process of the image-text constraint information is used for description. FIG. 7 is a schematic diagram of a method for determining image-text constraint information according to an embodiment of this application. Descriptions are provided with reference to operations shown in FIG. 7.

Operation 301: A server performs image feature extraction on each frame image located before an i^{th} frame image, to obtain an image feature of each frame image.

In some embodiments, the image-text constraint information obtained by the server may be implemented by consecutive image feature extraction and text feature extraction. For example, image feature extraction is first performed on each frame image located before the i^{th} frame image, to obtain the image feature of each frame image; then, text feature extraction is performed on description text associated with each frame image located before the i^{th} frame image, to obtain a text feature of each frame image; image features are separately fused for each frame image located before the i^{th} frame image, to obtain an image-text feature of each frame image; and weighted summation is performed on the image-text feature of each frame image, to obtain image-text constraint information of the i^{th} frame image.

In some embodiments, the server may extract, by using a machine learning model (for example, BLIP) configured to implement cross-mode feature extraction, an image feature of each frame image located before the i^{th} frame image, and extract, by using the image feature as constraint information, a text feature of the description text associated with each frame image located before the i^{th} frame image, to obtain the image-text feature of each frame image.

For example, FIG. 8 is a schematic diagram of an image-text feature extraction process according to an embodiment of this application. In this figure, an image-text feature is extracted by using a BLIP model. An implementation process may include inputting, by using a ViT model, each frame image located before the i^{th} frame image to perform visual feature, namely, image feature extraction, to obtain a corresponding image feature.

Operation 302: Perform, by using the image feature of each frame image as an image constraint, text feature extraction on the description text associated with each frame image located before the i^{th} frame image, to obtain an initial image-text feature of each frame image.

The image feature of each frame image is used as the image constraint, and text feature extraction is performed on the description text associated with each frame image located before the i^{th} frame image. To be specific, the image feature of each frame image is configured for guiding a text feature extraction process of the description text associated with the frame image, so that the text feature extraction process is consistent with image content, to improve accuracy and effectiveness of feature extraction. That is, the initial image-text feature is a text feature carrying the image feature.

Continuing the foregoing example, the description text associated with the frame image is inputted into the BLIP, and the image feature extracted from the frame image by using the ViT is used as constraint information, to obtain the text feature carrying the image constraint.

Operation 303: Obtain a second identifier feature configured for indicating an image-text mode, fuse the second identifier feature with the initial image-text feature, and use a fusion result as the image-text constraint information of the i^{th} frame image.

Continuing the foregoing example, for ease of calculation, the server further obtains the second identifier feature configured for indicating the image-text mode, and fuses the second identifier feature with the text feature carrying the image constraint, to obtain the initial image-text feature, and uses the initial image-text feature as the image-text constraint information of the i^{th} frame image. A size (1×3×768) of the text feature carrying the image constraint is the same as a size (1×3×768) of a flag bit in the image-text mode. In addition, there is a time sequence relationship between frame images in a frame image sequence. The server may further obtain time positioning information configured for representing the current frame image, and fuse the initial image-text feature with the time positioning information, to obtain a target image-text feature and use the target image-text feature as the image-text constraint information of the i^{th} frame image. The time positioning information may be configured for indicating a playing time point of a frame image in a target video, and the frame images in the frame image sequence are arranged according to corresponding time positioning information.

Operation 1023: Splice text constraint information and the image-text constraint information, to obtain target constraint information.

In some embodiments, the server obtains text constraint information for the i^{th} frame image in the foregoing determining manner for the text constraint information, and then obtains the image-text constraint information for the i^{th} frame image bin the foregoing determining manner for the image-text constraint information. The size of the text constraint information for the i^{th} frame image is the same as the size of the image-text constraint information for the i^{th} frame image, and the text constraint information and the image-text constraint information are fused, to obtain the target constraint information for the i^{th} frame image.

Operation 1024: Constrain a generation process of the i^{th} frame image with reference to each frame image located before the i^{th} frame image and based on the target constraint information, to obtain the i^{th} frame image.

In some embodiments, the server performs diffusion sampling on each frame image located before the i^{th} frame image, to obtain a corresponding noise image, and then performs denoising on the noise image through the target constraint information, to generate the i^{th} frame image.

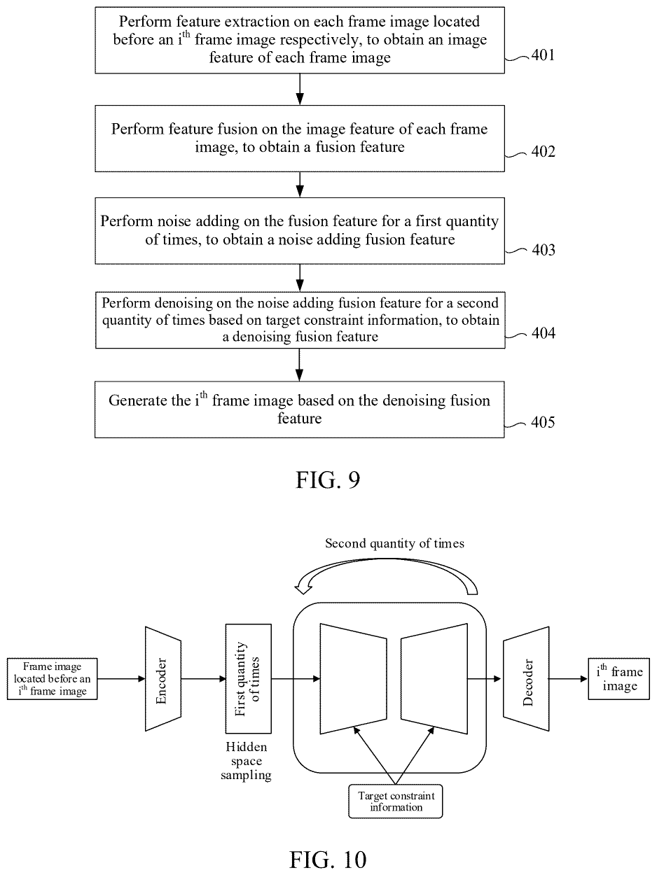

In some embodiments, a frame image generation process may be independently implemented by the terminal or the server, or may be collaboratively implemented by the terminal and the server. An example in which the server 200 in FIG. 1 independently performs the foregoing frame image generation process is used for description. FIG. 9 is a flowchart of a frame image generation process according to an embodiment of this application. Descriptions are provided with reference to operations shown in FIG. 9.

Operation 401: A server performs feature extraction on each frame image located before an i^{th} frame image respectively, to obtain an image feature of each frame image.

Operation 402: Perform feature fusion on the image feature of each frame image, to obtain a fusion feature.

The performing feature fusion on the image feature of each frame image may be performing feature splicing or feature superimposition on the image feature of each frame image, and an obtained spliced feature is used as the fusion feature.

In some embodiments, when generating the i^{th} frame image, to ensure consistency with an image located before the i^{th} frame image, the server performs feature extraction on each frame image located before the i^{th} frame image respectively, to obtain the image feature of each frame image. Extraction on the image feature may also be implemented based on a machine learning model.

For example, FIG. 10 is a diagram of a generation process of an i^{th} frame image according to an embodiment of this application. In this figure, the server first inputs a frame image located before the i^{th} frame image into an encoder for encoding, that is, performs feature extraction on the frame image located before the i^{th} frame image, to generate an image feature z (represented by using a vector) corresponding to a hidden space. Diffusion sampling (which may be implemented by using a diffusion model) is performed to obtain a hidden space representation of z at a moment T, denoising processing is performed on the moment T to perform prediction on a hidden space representation at a moment T−1, and the rest can be deduced by analogy to continue to perform prediction on a representation at the moment T−1 and a moment T−2 until prediction is performed at a moment T=0. Final prediction, namely, the generated i^{th} frame image is obtained through a decoder D.

Operation 403: Perform noise adding on the fusion feature for a first quantity of times, to obtain a noise adding fusion feature.

For example, still referring to FIG. 10, diffusion sampling on the image feature in the hidden space actually is performing noise adding on the fusion feature (that is, the fusion feature is obtained by fusing image features of a plurality of frame images) for the first quantity of times T (T is a positive integer greater than 1), to obtain the noise adding fusion feature. In some embodiments, when noise adding is performed, types of added noise include, but are not limited to, Gaussian noise, salt pepper noise, Poisson noise, and the like. Which type of noise that is to be added needs to be selected and may be determined according to an actual requirement. The Gaussian noise is noise that conforms to Gaussian distribution and that is added to the image feature, and a degree of noise adding may be controlled by adjusting a standard deviation of the Gaussian distribution. The salt pepper noise is adding black and white noise to an image. Pepper refers to black noise (0, 0, 0). Salt refers to white noise (255, 255, 255). A ratio of adding noise is controlled by setting a parameter value. A greater value indicates that more noise is added and the image is more severely damaged. The first quantity of times herein is a quantity of times of adding noise, namely, a preset quantity of times of adding noise for an image. A noise adding image may be obtained for each time of adding noise. After n times of noise adding is completed, a finally obtained noise image is used as an image on which noise adding is performed for subsequent processing.

Operation 404: Perform denoising on the noise adding fusion feature for a second quantity of times based on the target constraint information, to obtain a denoising fusion feature.

Continuing the foregoing example, after the corresponding noise adding fusion feature is obtained, denoising is performed for a second quantity of times, to obtain the denoising fusion feature. In some embodiments, the first quantity of times may be the same as or may be different from the second quantity of times. When the first quantity of times is equal to the second quantity of times, the first quantity of times is set to T. Noising adding is performed for the first quantity of times to obtain the noise adding fusion feature at the moment T, then denoising is performed, fusion feature prediction at the moment T−1 (namely, a denoised image corresponding to a noise adding image at the moment T−1) is performed on the noise adding fusion feature at the moment T, and the rest can be deduced by analogy to continue to perform prediction on the denoised image at the moment T−1 and a moment T−2 until prediction is performed at the moment T=0, that is, an image feature of the denoised image is obtained when T is equal to 0.

In an some embodiments process, in a process of performing denoising on the noise adding fusion feature for the second quantity of times, the target constraint information is configured for limiting image prediction in the denoising process, that is, guiding the denoising process, so that an image feature obtained through denoising conforms to an image feature indicated by the target constraint information.

Operation 405: Obtain through generation the i^{th} frame image based on the denoising fusion feature.

Continuing the foregoing example, the server performs image reconstruction on the denoising fusion feature obtained by performing denoising for the second quantity of times, to obtain the i^{th} frame image. That is, the server decodes the denoising fusion feature, to obtain the i^{th} frame image.

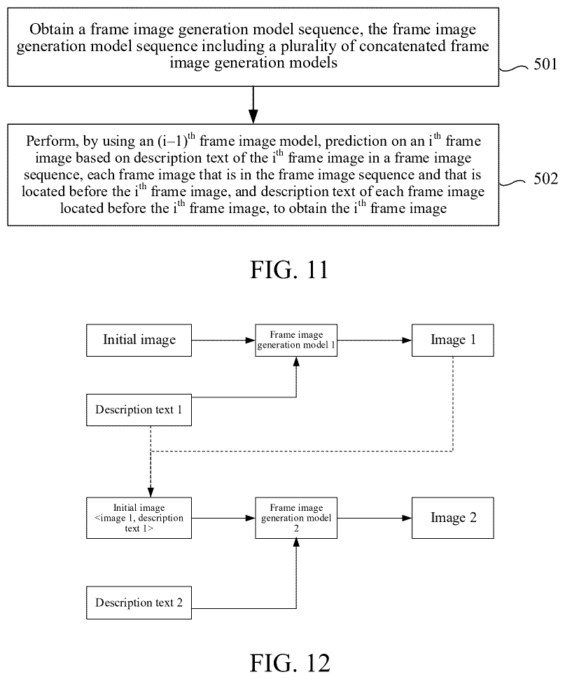

In some embodiments, a frame image generation process based on a machine learning model may be independently implemented by the terminal or the server, or may be collaboratively implemented by the terminal and the server. An example in which the server 200 in FIG. 1 independently performs the foregoing frame image generation process based on a machine learning model is used for description. FIG. 11 shows a frame image generation method based on a machine learning model according to an embodiment of this application. Descriptions are provided with reference to operations shown in FIG. 11.

Operation 501: A server obtains a frame image generation model sequence, the frame image generation model sequence includes a plurality of concatenated frame image generation models.

There is a one-to-one correspondence between the frame image generation models and frame images other than an initial image (namely, a 1^{st} frame image).

In some embodiments, the server may generate a corresponding frame image based on a machine learning model. The machine learning model may be referred to as a frame image generation model. When an i^{th} frame image is generated, all frame images located before the i^{th} frame image and corresponding description text need to be used. Therefore, the server generates a corresponding frame image by using a plurality of concatenated frame image generation models. That is, there is a one-to-one correspondence between a quantity of frame image generation models and frame images other than the initial image in the frame image sequence to be generated. For example, if a quantity of frame images in the frame image sequence to be generated is N, N−1 concatenated frame image generation models may be used, to generate remaining N−1 frame images other than the 1^{st} frame image.

For example, FIG. 12 is a flowchart of concatenated frame image generation models according to an embodiment of this application. Two concatenated frame image generation models are shown in the figure. Input information is an initial image, and output information is a frame image sequence including three frame images. A generation process of an image 1 is obtained through prediction by performing, by using a frame image generation model 1, image 1 prediction on the initial image and description text 1 configured for describing image content of the image 1. A generation process of an image 2 is obtained through prediction by performing, by using a frame image generation model 2, image 2 prediction on the initial image, the generated image 1, description text 1 associated with the image 1, and description text 2 associated with the image 2. Finally, the initial image, the image 1, and the image 2 are synthesized into a target video.

Operation 502: Perform, by using an (i−1)^{th} frame image model, prediction on the i^{th} frame image based on the description text of the i^{th} frame image in the frame image sequence, each frame image that is in the frame image sequence and that is located before the i^{th} frame image, and the description text of each frame image located before the i^{th} frame image, to obtain the i^{th} frame image.

Continuing the foregoing example, prediction is performed on the i^{th} frame image by using an (i−1)^{th} frame image model based on the description text of the i^{th} frame image in the frame image sequence, each frame image that is in the frame image sequence and that is located before the i^{th} frame image, and the description text of each frame image located before the i^{th} frame image, to obtain the i^{th} frame image.

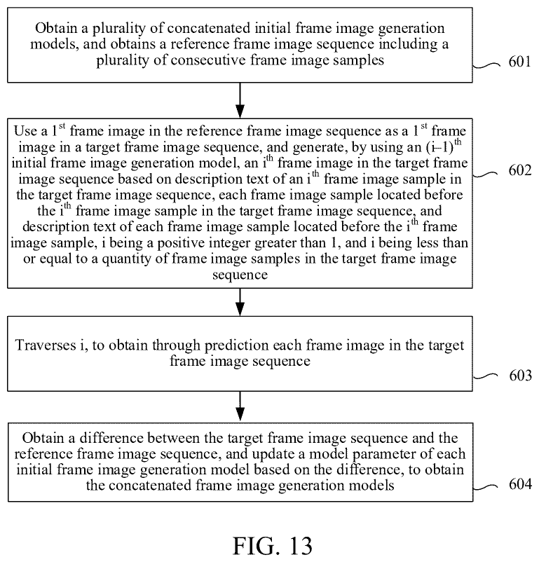

In some embodiments, a training process of a frame image generation model may be independently implemented by the terminal or the server, or may be collaboratively implemented by the terminal and the server. An example in which the server 200 in FIG. 1 independently performs the foregoing training process of the frame image generation model is used for description. FIG. 13 is a schematic diagram of a training process of a frame image generation model according to an embodiment of this application. Descriptions are provided with reference to operations shown in FIG. 13.

Operation 601: A server obtains a plurality of concatenated initial frame image generation models, and obtains a reference frame image sequence including a plurality of consecutive frame image samples.

The frame image sample carries description text configured for describing a next adjacent frame image sample.

For example, referring to a plurality of concatenated frame image generation models shown in FIG. 12, the server first obtains the initial frame image generation model on which training has not been completed, and obtains a reference frame image sequence configured for training the initial frame image generation model. The reference frame image sequence includes a plurality of consecutive frame image samples, and the frame image samples carry the description text configured for describing the next adjacent frame image sample. For example, a 1^{st} frame image sample is that a character A is standing, a 2^{nd} frame image sample is that the character A is in a running ready posture, and a 3^{rd} frame image sample is that the character A is running. In this case, the 1^{st} frame image sample may carry description text “the character A is in a running ready posture”.

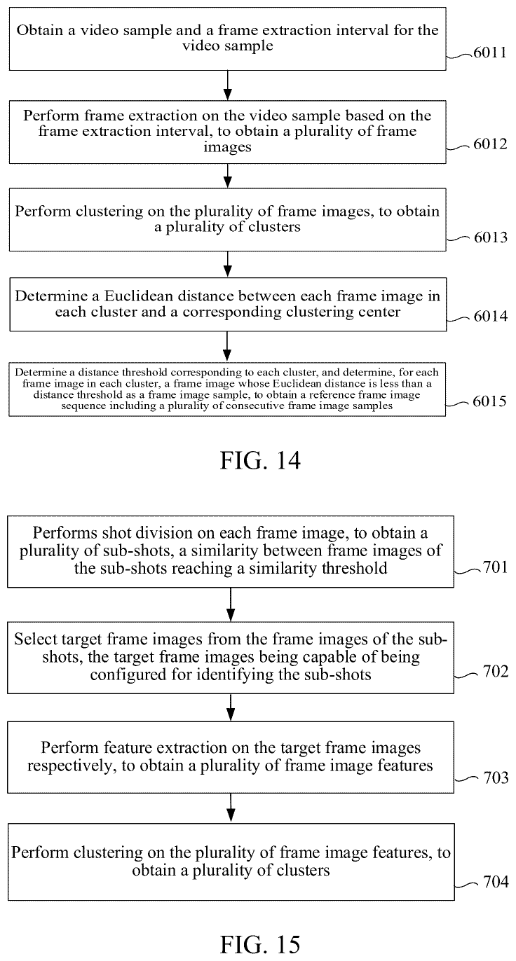

An obtaining manner for the reference frame image sequence is described. In some embodiments, FIG. 14 is a schematic diagram of a video sample processing procedure according to an embodiment of this application. Descriptions are provided with reference to operations shown in FIG. 14.

Operation 6011: A server obtains a video sample and a frame extraction interval for the video sample.

In some embodiments, to generate, for an inputted image by using the concatenated frame image generation models, a plurality of consecutive frame images having a style of a film or television drama work, to obtain a corresponding video having the style of the film or television drama, video samples may be collected by using many films or television dramas, and the initial frame image generation model is trained by using the video samples having styles of the films or television dramas, so that a feature of the inputted image is similar to a feature space of the film or television drama.

Operation 6012: Perform frame extraction on the video sample based on the frame extraction interval, to obtain a plurality of frame images.

In some embodiments, to reduce consumption of calculation resources, the server first performs frame extraction on each video sample according to a preset frame extraction interval. For example, the frame extraction interval is 1 frame per second or 1 frame per 2 seconds. The frame extraction interval may be adjusted according to an actual condition.

Operation 6013: Perform clustering on the plurality of frame images, to obtain a plurality of clusters.

In some embodiments, a clustering process for a video sample may be independently implemented by the terminal or the server, or may be collaboratively implemented by the terminal and the server. An example in which the server 200 in FIG. 1 independently performs the foregoing clustering process for the video sample is used for description. FIG. 15 is a flowchart of a clustering process for a video sample according to an embodiment of this application. Descriptions are provided with reference to operations shown in FIG. 15.

Operation 701: A server performs shot division on each frame image, to obtain a plurality of sub-shots, a similarity between frame images of the sub-shots reaching a similarity threshold.

In some embodiments, the server performs shot division on the plurality of frame images obtained through frame extraction processing, to obtain the plurality of sub-shots. Content of images of the same sub-shot is almost the same (there may be only slight changes in light exposure, an action, and a viewing angle of an object). In other words, the similarity between the frame images of the sub-shots reaching the similarity threshold.

Operation 702: Select target frame images from the frame images of the sub-shots, the target frame images being capable of being configured for identifying the sub-shots.

In some embodiments, because the similarity between the frame images of the sub-shots reaches the similarity threshold, to reduce consumption of calculation resources, the target frame images may be selected from the sub-shots. The target frame images may be configured for identifying the sub-shots to which the target frame images belong.

Operation 703: Perform feature extraction on the target frame images respectively, to obtain a plurality of frame image features.

In some embodiments, there is a one-to-one correspondence between the frame image features and the target frame images.

Operation 704: Perform clustering on the plurality of frame image features, to obtain a plurality of clusters.

In some embodiments, the server may randomly extract one frame image from each sub-shot to represent the sub-shot, and perform feature extraction on the target frame images respectively by using an image branch of a cross-mode CLIP model, to obtain the plurality of frame image features. K-means clustering is performed on all frame image features, to obtain clustering centers of K clusters, and a clustering center to which each frame image belongs is found.

Operation 6014: Determine a Euclidean distance between each frame image in each cluster and a corresponding clustering center.

In some embodiments, the server calculates the Euclidean distance between each frame image in each cluster and the corresponding clustering center.

Operation 6015: Determine a distance threshold corresponding to each cluster, and determine, for each frame image in each cluster, a frame image whose Euclidean distance is less than a distance threshold as a frame image sample, to obtain the reference frame image sequence including the plurality of consecutive frame image samples.

In some embodiments, the server obtains each corresponding distance threshold, and reserves, for each cluster, the frame image sample whose Euclidean distance is less than the distance threshold. Accordingly, K clusters are obtained, and each cluster includes a relatively clean image.

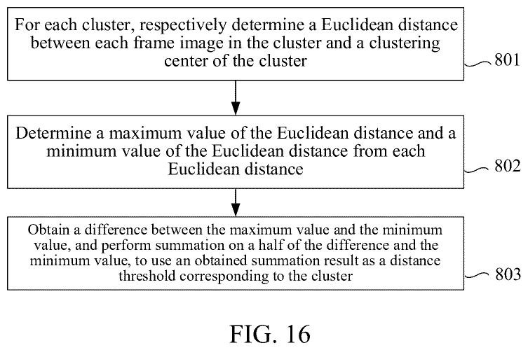

In some embodiments, a determining process of the distance threshold may be independently implemented by the terminal or the server, or may be collaboratively implemented by the terminal and the server. An example in which the server 200 in FIG. 1 independently performs the foregoing determining process of the distance threshold is used for description. FIG. 16 is a schematic diagram of a determining process of a distance threshold according to an embodiment of this application. Descriptions are provided with reference to operations shown in FIG. 16.

Operation 801: For each cluster, a server respectively determines the Euclidean distance between each frame image in the cluster and the clustering center of the cluster.

In some embodiments, for each cluster, the Euclidean distance between each frame image in the cluster and the clustering center of the cluster is determined.

Operation 802: Determine the maximum value of the Euclidean distance and a minimum value of the Euclidean distance from each Euclidean distance.

In some embodiments, the server determines the maximum value max of the Euclidean distance in each cluster, and the minimum value min of the Euclidean distance, and records a threshold thr=(max−min)/2+min.

Operation 803: Obtain a difference between the maximum value and the minimum value, and perform summation on a half of the difference and the minimum value, to use an obtained summation result as a distance threshold corresponding to the cluster.

In some embodiments, the server determines the difference (max−min) between the maximum value and the minimum value, performs summation, namely, (max−min)/2+min on a half of the difference, namely, (max−min)/2 and the minimum value min, and uses an obtained summation result as a distance threshold corresponding to the cluster, which may be recorded as thr. That is, thr=(max−min)/2+min.

Operation 602: Use a 1^{st} frame image in the reference frame image sequence as a 1^{st} frame image in a target frame image sequence, and generate, by using an (i−1)^{th} initial frame image generation model, an i^{th} frame image in the target frame image sequence based on description text of an i^{th} frame image sample in the target frame image sequence, each frame image sample located before the i^{th} frame image sample in the target frame image sequence, and description text of each frame image sample located before the i^{th} frame image sample, i being a positive integer greater than 1, and i being less than or equal to a quantity of frame image samples in the target frame image sequence.

In some embodiments, the server uses the 1^{st} frame image in the reference frame image sequence as the 1^{st} frame image in the target frame image sequence, and generates the i^{th} frame image by using the (i−1)^{th} initial frame image generation model. In a process of generating the i^{th} frame image, the server generates target constraint information for the i^{th} frame image in the target frame image sequence based on the description text of the i^{th} frame image in the target frame image sequence, each frame image that is in the target frame image sequence and that is located before the i^{th} frame image, and the description text of each frame image located before the i^{th} frame image, and constrains, based on the target constraint information, the generation process of the (i−1)^{th} initial frame image generation model for the i^{th} frame image in the target frame image sequence.

Operation 603: Traverse i, to obtain through prediction each frame image in the target frame image sequence.

In some embodiments, the server traverses i, that is, iteratively performs, for different values of i, the foregoing generation process on the i^{th} frame image in the target frame image sequence, to obtain through prediction each frame image in the target frame image sequence.

Operation 604: Obtain a difference between the target frame image sequence and the reference frame image sequence, and update a model parameter of each initial frame image generation model based on the difference, to obtain the concatenated frame image generation models.

In some embodiments, for frame images other than the 1^{st} frame image in the target frame image sequence, a difference between the current frame image and a frame image sample at a current position in the reference frame image sequence is sequentially determined, and the model parameter of the corresponding initial frame image generation model is updated based on the corresponding difference, to obtain the plurality of concatenated frame image generation models on which training is completed.

For example, the difference between the current frame image and the frame image sample at the current position in the reference frame image sequence may be calculated by using an MSE loss. That is, a mean square error of pixel values at the same positions of the current frame image in the target frame image sequence and the frame image sample at a corresponding position in the reference frame image sequence is used as a difference between the current frame image and the frame image sample at the current position in the reference frame image sequence.

Operation 103: Perform video synthesis on each frame image in the frame image sequence, to obtain a target video.

In some embodiments, the server performs video synthesis on each frame image in the generated frame image sequence, to obtain the target video.

In some embodiments, the server may further determine attribute information of the target video in the following manner: The server obtains a frame rate of the target video, the frame rate being configured for indicating a quantity of consecutive frame images played per second in the target video; and determines a ratio of a quantity of frame images in the frame image sequence to the frame rate as duration of the target video, and determines the duration as the attribute information of the target video.

In some embodiments, a video synthesis manner may be: The server obtains a preset frame rate, and synthesizes, according to the frame rate, each frame image in the frame image sequence into the target video having target duration. The target duration is equal to the ratio of the quantity of frame images in the frame image sequence to the preset frame rate.

For example, if the quantity of frame images in the frame image sequence is 120, and the preset frame rate is 15 frames per second (fps), the target duration of the generated target video is 120/15, and is equal to 8 seconds. If the preset frame rate is 20 fps, the target duration of the generated target video is 120/20, and is equal to 6 seconds.

When each frame image in the frame image sequence to be generated is generated, the generation process of each frame image is constrained by using each frame image located before the frame image and the description text associated with each frame image located before the frame image as the target constraint information. Accordingly, the content of a generated frame image is consistent with content of each frame image located before the frame image. In addition, the frame image generation model is obtained through training by using a video sample having a style of a film or television drama. A plurality of consecutive frame images having a corresponding style of a film or television drama may be generated from one initial image, to generate a target video having the style of the film or television drama. Accordingly, the frame image generation model can be configured for generating an imitation of a film or television drama work from one image, thereby enriching the expression content of the image. In addition, corresponding constraint information is generated based on the frame image located before the current frame image, to perform prediction on the current frame image, so that a video generation process can be disassembled into a prediction task of a next frame image, thereby implementing efficient and fast generation of consecutive frame images.

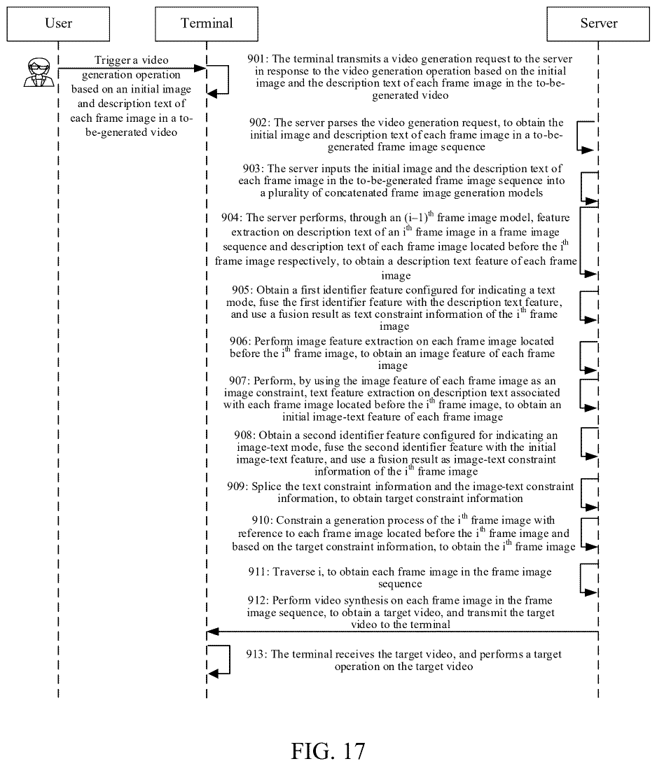

The following continues to describe a video generation method provided in the embodiments of this application. FIG. 17 is another schematic flowchart of a video generation method according to an embodiment of this application. An example in which a plurality of concatenated frame image generation models is run on a server is used. Referring to FIG. 17, the video generation method provided in the embodiments of this application is collaboratively implemented by a terminal and a server.

Operation 901: A terminal transmits a video generation request to a server in response to a video generation operation based on an initial image and description text of each frame image in a video to be generated.

For example, the video to be generated is a generated target video. The video to be generated includes a frame image sequence to be generated. The video generation request carries an initial image used as a 1^{st} frame image in the frame image sequence to be generated and the description text of each frame image in the frame image sequence to be generated.

Operation 902: The server parses the video generation request, to obtain the initial image and the description text of each frame image in the frame image sequence to be generated.

Operation 903: The server inputs the initial image and the description text of each frame image in the frame image sequence to be generated into a plurality of concatenated frame image generation models.

For example, there is a one-to-one correspondence between the frame image generation models and frame images other than the initial image. The server determines the obtained initial image as the 1^{st} frame image in the frame image sequence to be generated, and obtains the description text of each frame image in the frame image sequence. Before using the plurality of concatenated frame image generation models, the server may train the plurality of concatenated frame image generation models in the following manner: The server obtains a plurality of concatenated initial frame image generation models, and obtains a reference frame image sequence including a plurality of consecutive frame image samples, the frame image samples carrying description text configured for describing a next adjacent frame image sample; uses a 1^{st} frame image sample in the reference frame image sequence as a 1^{st} frame image in a target frame image sequence, and generates, by using an (i−1)^{th} initial frame image generation model, an i^{th} frame image in the target frame image sequence based on description text of an i^{th} frame image in the target frame image sequence, each frame image that is in the target frame image sequence and that is located before the i^{th} frame image, and description text of each frame image located before the i^{th} frame image, traverses i, to obtain through prediction each frame image in the target frame image sequence; and obtains a difference between the target frame image sequence and the reference frame image sequence, and updates a model parameter of each initial frame image generation model based on the difference, to obtain the concatenated frame image generation models.

Operation 904: A server performs, through an (i−1)^{th} frame image model, feature extraction on description text of an i^{th} frame image in a frame image sequence and description text of each frame image located before the i^{th} frame image respectively, to obtain a description text feature of each frame image.

Operation 905: Obtain a first identifier feature configured for indicating a text mode, fuse the first identifier feature with the description text feature, and use a fusion result as text constraint information of the i^{th} frame image.

Operation 906: Perform image feature extraction on each frame image located before an i^{th} frame image, to obtain an image feature of each frame image.

Operation 907: Perform, by using the image feature of each frame image as an image constraint, text feature extraction on the description text associated with each frame image located before the i^{th} frame image, to obtain an initial image-text feature of each frame image.

Operation 908: Obtain a second identifier feature configured for indicating an image-text mode, fuse the second identifier feature with the initial image-text feature, and use a fusion result as the image-text constraint information of the i^{th} frame image.

Operation 909: Splice text constraint information and the image-text constraint information, to obtain target constraint information.

Operation 910: Constrain a generation process of the i^{th} frame image with reference to each frame image located before the i^{th} frame image and based on the target constraint information, to obtain the i^{th} frame image.

Operation 911: Traverse i, to obtain each frame image in the frame image sequence.

Operation 912: Perform video synthesis on each frame image in the frame image sequence, to obtain the target video, and transmit the target video to the terminal.

Operation 913: The terminal receives the target video returned by the server, and performs a target operation on the target video.

The target operation includes one or more of the following operations: playing, downloading, sharing, and the like.

The corresponding constraint information is generated based on the frame image located before the current frame image, to perform prediction on the current frame image, so that a video generation process can be disassembled into a prediction task of a next frame image, thereby implementing efficient and fast generation of consecutive frame images, and content of a generated frame image is consistent with content of each frame image located before the frame image.

“Plurality of” mentioned in the specification means two or more.

The following describes an exemplary application of this embodiment of this application in an some embodiments scene.

In a scene of a film or television drama, when uploading an image, a user usually expects to animate the image through a video technology, so that the image is of a film or television drama type, that is, make the image move and action performance of the image similar to that of a film or television drama style, for example, a short video clip displaying a character expression change or scenery switch. A related text-to-image technology has a good effect on generating cartoons and artistic scenery, but has a poor effect on generating images related to a scene of a film or television drama and a character having a film or television drama style. Alternatively, the image-to-text technology cannot ensure consistency between an output image and an input image in scenes due to a problem of random noise. Generation results are usually inharmonious, for example, characters are inconsistent, backgrounds are inconsistent, and scenes are inconsistent.

Based on this, the embodiments of this application provide a video generation method. The method is based on an image generation technology of a hidden space of a diffusion model, to design a consecutive frame generation model (which may also be referred to as a sequence model, namely, the concatenated frame image generation models in the foregoing descriptions) of a film or television drama work, to convert video generation into consecutive frame image generation. To be specific, an image is inputted to generate a next frame image consistent with the image, to complete a prediction task for a next frame image of a current image. In addition, to improve a correlation between adjacent frame images, when a next frame image of the image is generated, a process in which the consecutive frame generation model generates the next frame image is constrained with reference to historical frame information (namely, related information of a frame image located before the current frame image), so that the generated next frame image is consistent with the current image. In addition, a training set is collected through many films or television dramas, and a hidden space mapping module of the consecutive frame generation model is trained by using a training set of the film or television drama work, so that a feature of the input image is similar to a feature space of the film or television drama.

According to the video generation method provided in the embodiments of this application, the training set is collected based on many films or television dramas as supervision information for image generation; and a consecutive frame generation framework is further designed, to generate a next frame image based on the inputted image, thereby forming the consecutive frame generation model (namely, the frame image generation model in the foregoing descriptions). In addition, a scene and content correlation between adjacent frame images in a video is further improved through an accumulated input of historical frame image information, so that adjacent frame images in the generated video are more harmonious.

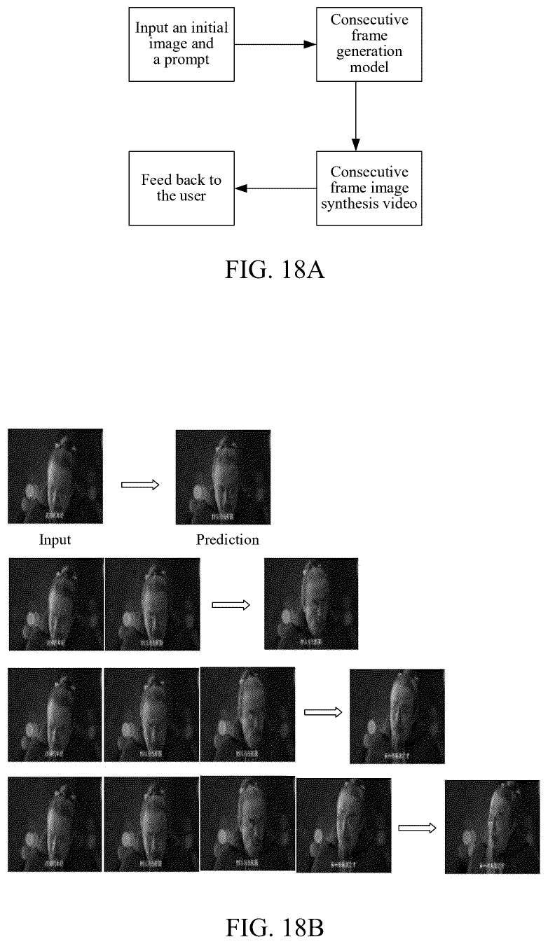

For example, FIG. 18A is a schematic diagram of a summarization procedure of a video generation method according to an embodiment of this application. First, an initial image is given, and a plurality of subsequent frame images conforming to a data space of a film or television drama are consecutively generated by using a consecutive frame generation model. Then, video synthesis is performed on consecutive frame images to obtain a target video. In some embodiments, a user uploads the initial image and a prompt (such as “cute”) related to a video that the user wants to generate, and an electronic device (a server or a terminal) on which a consecutive frame generation model is deployed selects a matching consecutive frame generation model according to the initial image uploaded by the user (for example, if a character is uploaded, a consecutive frame generation model trained by characters is selected; and if a scenery image is uploaded, a consecutive frame generation model trained by scenery images is selected). Consecutive frame images are generated by using the selected consecutive frame generation model, the generated consecutive frame images and the initial image are combined into the target video, and the target video is returned to the user. For example, FIG. 18B is a visualization schematic diagram of generation of a plurality of frame images according to an embodiment of this application. In the figure, a user enters an image, to obtain through prediction four new frame images. A synthesis video includes five frame images. Other than a 1^{st} frame image, the other frame images are generated based on other frame images located before the frame image with reference to corresponding description text.

A generation process of the consecutive frame images is described. Referring to FIG. 12, the generation process is as follows: (1) generating a result once for an initial image and a prompt (namely, description text 1 in the foregoing descriptions) uploaded by a user, where the result includes a plurality of images; (2) selecting one image from the plurality of images and using the image as an image at a current moment (namely, the image 1 in the foregoing descriptions); (3) generating a result once by inputting a historical moment image, a historical prompt, and a prompt at a current moment (when the user does not enter the prompt at the current moment, the prompt at the current moment is set to null) into a model; and (4) repeating operation (2) and operation (3) until N images are generated. For example, the user uploads an initial image 0 and the description text 1, to generate an image 1 by using the consecutive frame generation model, and then, the initial image 0, the description text 1, the image 1, and description text 2 are inputted into the consecutive frame generation model again, to generate an image 2. Accordingly, the foregoing process is repeatedly performed, to sequentially generate an image 3, an image 4, . . . , and an image N, where N is a quantity of generated frame images. If N is known, a target video of different duration may be synthesized according to different frame rates. For example, 75 frame images are generated, and when the frame rate is 15 fps, a video of 75/15, namely, 5 seconds may be generated.

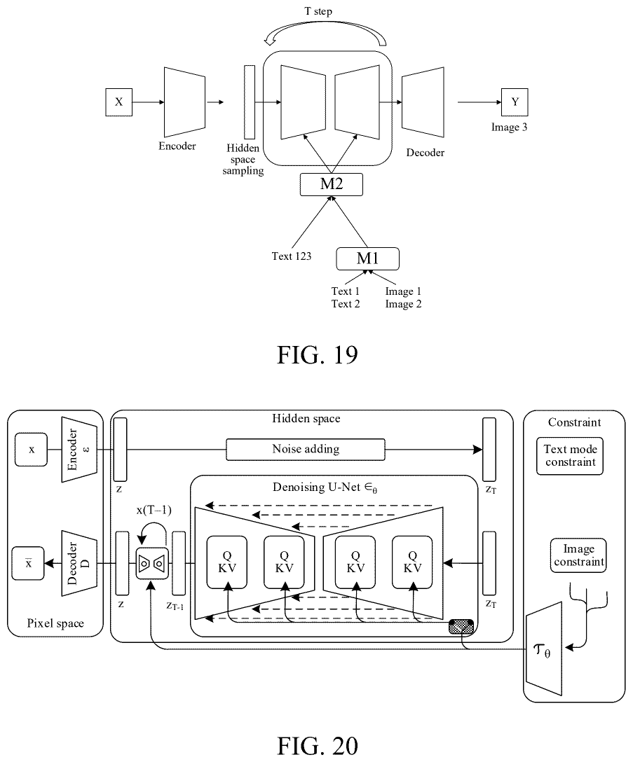

The consecutive frame generation model configured to generate consecutive frame images is described. FIG. 19 is a schematic diagram of a structure of a consecutive frame generation model according to an embodiment of this application. After a text feature is extracted from historical description text and an image feature is extracted from a historical image, the historical text feature and the historical image feature are fused to obtain historical information. Current input information for a user is only an image. If there is no description text, the description text is inputted into the consecutive frame generation model by using a default value (which is null). After a text feature is extracted from description text (for example, text 3 in the figure) at a current moment, the text feature is spliced with the historical information to finally form constraint information generated by the consecutive frame generation model at the current moment. General processing of the consecutive frame generation model is implemented based on a hidden space diffusion (stable-diffusion) generation model. First, a 256×256 noise image x generated by using Gaussian random noise is used as a whole input, and a hidden space representation is obtained by using an encoder. A hidden space representation of the noise image x at a moment T is obtained through sampling by using the hidden space diffusion model (in this case, T is not related to a current moment in a sequence frame generation process, the T moments herein may be understood as T recovery operations, and overall video sequence generation may be understood as that each frame is an image generated by a generation model including T operations in a video frame sequence). A hidden space representation at a moment T−1 is predicted based on the hidden space representation at the moment T through a denoising U-Net module (where the denoising module includes historical constraint information). The representation at the moment T−1 continues to be inputted into an input end of the U-Net to predict a representation at a moment T−2. The rest can be deduced by analogy to complete prediction of the T operations, to obtain prediction of a representation at a moment T=0. That the moment T=0 represents that a generated image y is obtained through a decoder. Accordingly, a process of generating one frame image, that is, generating an image 1 from an initial image is completed.

An open-source stable-diffusion model is described here. FIG. 20 is a schematic diagram of a standard diffusion model according to an embodiment of this application. It is assumed that each noise image is obtained by performing noise sampling through T operations. Denoising of T operations is performed on this process, to predict an original noise image. For a generation process of the model, refer to the following figure: First, a noise image x is randomly generated, a hidden space representation z is generated through an encoder ε, a hidden space representation z at a moment T is obtained through sampling by using a diffusion model, and prediction of a hidden space representation at a moment T−1 is performed based on the hidden space representation z at the moment T through a u-net module. The rest is deduced by analogy. Representation prediction at a moment T−1 and a moment T−2 continues to be performed until prediction at a moment T=0 is performed. Final prediction, namely, the generated frame image is obtained through a decoder D. During training, to ensure that an image generated in specified text is related to text, text encoding (or an image) is used as an attention feature in a denoising U-Net module, so that a text attention constraint is imposed in a denoising process. In addition, in the generated image, an image in an image-text mark sample pair is used as surveillance information, thereby ensuring that an image generated by the model is related to the text when the specified text is inputted. In some embodiments, an image of a user may alternatively be provided, text in the foregoing process is replaced with the image as a constraint condition, and the foregoing process is used to generate a next image (also referred to as an img2img process).

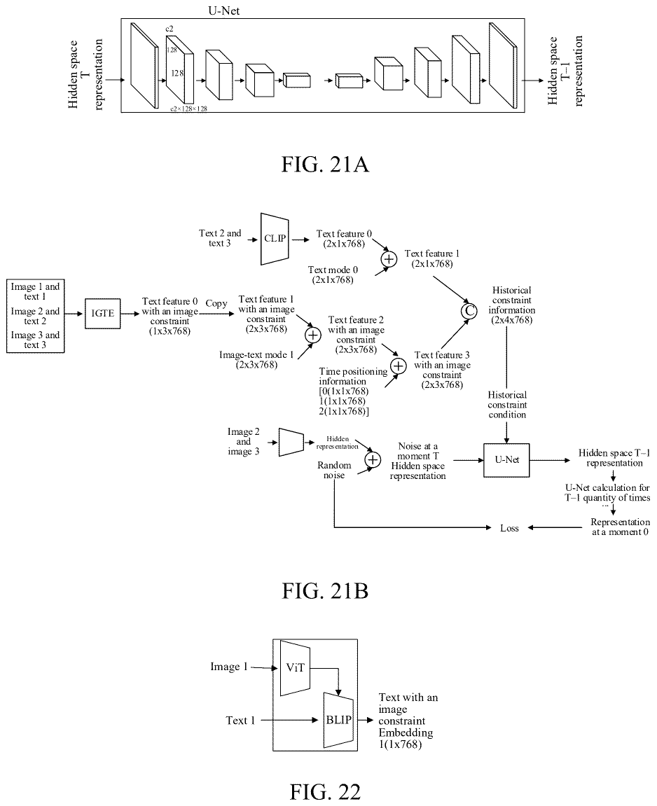

The denoising U-Net module is described. FIG. 21A is a schematic diagram of a U-Net process to which no constraint information is added according to an embodiment of this application. Representation prediction at a moment T−1 is obtained based on a hidden space feature at a moment T by using a U-Net. In an application scenario in which historical image-text information needs to be used as constraint information to predict a new image, a new constraint that can be used to process historical information may be added based on a U-Net structure shown in FIG. 21A. FIG. 21B is a schematic diagram of a U-Net in which constraint information is added according to an embodiment of this application. IGTE is a BLIP-based text extraction model. Image-text constraint information is determined through the IGTE. The BLIP-based text extraction model is described. FIG. 22 is a schematic diagram of a structure of a BLIP-based text extraction model according to an embodiment of this application. In FIG. 22, image feature extraction is performed on an image 1 through ViT, to obtain an image feature, text feature extraction is performed on the corresponding description text through BLIP, and image constraint text is generated in combination with the image feature obtained by extraction through the VIT. In some embodiments, the IGTE directly uses an open-source model weight, and a model parameter of the model does not need to be updated subsequently. In some embodiments, through FIG. 21B, for all historical text (text 1 and text 2), a text feature 0 (namely, the description text feature in the foregoing descriptions) is extracted through a CLIP text branch. The text feature 0 is a matrix feature that is formed by a plurality of text vectors and whose size is 2×1×768. Then, a flag bit 0 (whose size represented by using a vector is 2×1×768) representing a text mode is added to obtain a text feature 1. The text feature 1 is also a matrix feature that is formed by a plurality of text vectors and whose size is 2×1×768. The flag bit represents a 2×1×768 three-dimensional matrix, and elements in the matrix are 0. For all historical and current image-text information, image-text feature extraction is performed through an IGTE model, to obtain a text feature (namely, the image-text feature in the foregoing descriptions) with an image constraint 0. The text feature with the image constraint is a matrix feature whose size is 1×3×768. To align a first dimension of the text feature 0, the text feature 0 with the image constraint is copied once along the first dimension to obtain a text feature 1 with an image constraint, a size of the text feature 1 with the image constraint is a 2×3×768 matrix, and then a flag bit (a size of the flag bit is 2×3×768) representing an image-text mode is added to obtain a text feature 2 with an image constraint. The text feature 2 with the image constraint is a matrix feature whose size is 2×3×768. Then, a text feature 3 (a matrix feature whose size is 2×3×768) (2×3×768) with an image constraint is obtained in combination with a time sequence flag bit. Finally, the text feature 1 and the text feature 3 with the image constraint are spliced to obtain final historical constraint information (a matrix feature whose size is 2×4×768). “+” represents vector addition, and “C” represents vector splicing. The historical constraint information is inputted into a denoising U-Net, and a denoising process with constraint information is performed on the historical noise adding hidden representation in FIG. 1 and FIG. 2 for T times, to obtain noise prediction at a final moment 0. That is, the hidden representation in FIG. 1 and FIG. 2 may be restored by subtracting the noise prediction at the moment 0 from the noise adding representation. In some embodiments, during image or text feature extraction, an image branch of a cross-mode CLIP model is used to extract an image feature and a text branch of the cross-mode CLIP model is used to extract a text feature. An open-source model weight is directly used, and a model parameter of the CLIP model does not need to be updated subsequently.

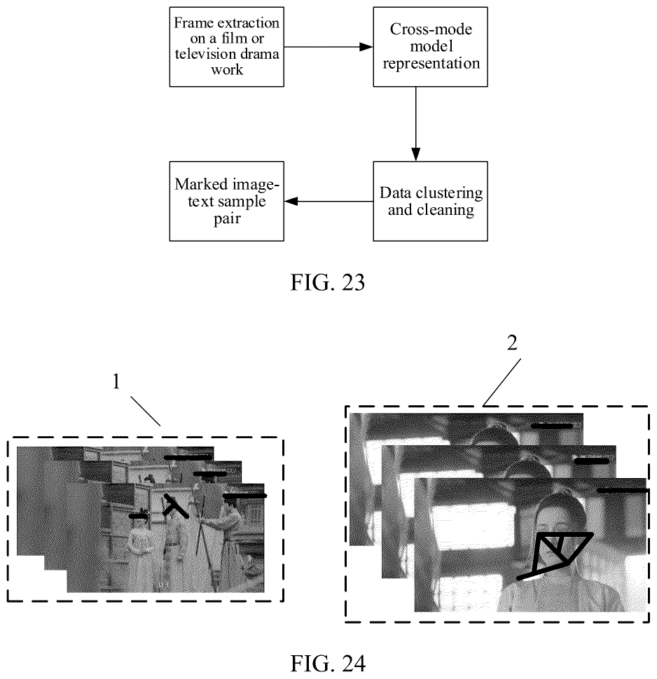

Collection of training data (namely, the reference frame image sequence obtained based on the video sample in the foregoing descriptions) is described herewith. In some embodiments, for sample data needed for training a sequence model, FIG. 23 is a schematic diagram of a training data collection procedure according to an embodiment of this application. Collection of training data (namely, the video sample in the foregoing descriptions) includes at least the following four operations: (1) performing frame extraction on a film or television drama work; (2) performing cross-mode model representation; (3) performing data clustering and cleaning; and (4) marking an image-text sample pair. Implementation of performing frame extraction on a film or television drama work may include: extracting one frame per second (where a frame extraction interval may be adjusted as needed, for example, extracting one frame per 2 seconds) from a film or television drama video. Shot division is performed on frame extraction, to obtain a plurality of sub-shots, and each sub-shot includes a plurality of frame images. FIG. 24 is a schematic diagram of a sub-shot operation on a video sample according to an embodiment of this application. A serial number 1 and a serial number 2 respectively correspond to different adjacent sub-shots. Image content in the same sub-shot is almost the same (there are only slight changes in light exposure, actions, and a viewing angle of an object). In this case, a sequence image in each sub-shot may be used as surveillance information generated by the sequence image. The surveillance information is: a sequence image 1 shown by the serial number 1 is used as a constraint input model, and the model needs to generate a result that is similar to that of the sequence image 2. In this case, the sequence image 2 is generation surveillance information of the sequence image 1.

In some embodiments, an implementation of a cross-mode model representation is: randomly extracting one image from each sub-shot to represent the sub-shot, and performing cross-mode feature representation extraction on the image. An image branch of an open-source cross-mode CLIP model is used in this specification to extract a video frame representation.

In some embodiments, implementation of data clustering and cleaning includes: (1) performing K-means clustering on all the representations (namely, the frame image features in the foregoing descriptions), to obtain K clustering (for example, a cluster 2) centers; (2) finding, for each frame, a clustering center to which the frame belongs; (3) calculating a Euclidean distance between a frame and a center in each cluster, to obtain a minimum distance min and a maximum distance max in the cluster, and record a threshold thr=(max−min)/2+min; and (4) for each cluster, only a sample whose distance to the center is less than the threshold thr is stored. Accordingly, K clusters are obtained, and each cluster includes a relatively clean image.

In some embodiments, implementation of a marked image-text sample pair is as follows: For all images obtained through clustering, description text of the images is marked. For example, image content is that a person is talking, and corresponding description text is marked as “a man wearing a suit is talking, and a half-body photo”, and the like. Finally, the marked image-text sample pair is obtained. Because one image represents one sub-shot in this case, sequence images in the sub-shot share same text information with the image.

A training process of a consecutive frame generation model is described. FIG. 20 shows a stable-diffusion-based sequence model, including a CLIP model configured to extract a prompt text feature, a VAE model configured to decode and generate an image, a diffusion model (diffusers) configured to generate random noise, and a U-Net configured to perform denoising. The VAE, CLIP, BLIP, and U-Net models each are initialized by using an open-source model weight, and the VIE, the CLIP, and the BLIP keep the open-source model weight. These models do not perform learning, and only the U-Net model is trained. x images of each sub-shot are collected from a data set (a video sample in the foregoing descriptions). Because different sub-shots have different quantities of images, to avoid a data volume difference, the model specifies every three images as a sequence data group. Therefore, each sub-shot has three images. For a sub-shot having more than three images, three consecutive images (for example, for five images: images 123, images 234, and images 345) are traversed to form three sequence data groups. For N sequence data groups in full training, each bs of sequence data is inputted into the model as a batch to learn and update model parameters, and N/bs batch of data is learned in total, which is used as one round of model training. During learning of each batch of data, the U-Net network in FIG. 21B is used as a to-be-learned parameter according to the foregoing process: (1) performing forward calculation on input data to obtain noise prediction; (2) calculating an MSE loss of noise prediction; (3) obtaining an update gradient of the model parameter through backward calculation; and (4) updating a learning parameter of the model in an SGD gradient update method, to complete batch training. The foregoing operations are repeated to complete training of all (N/bs) batches and end an iteration. Initially, a learning rate of 0.0005 may be used. After every 10 rounds of learning, the learning rate becomes 0.1 times of the original learning rate. Whether to continue training is determined according to whether the loss decreases. If the loss no longer decreases, training is not performed again. Alternatively, when a specified round of iteration is reached, for example, 100 epoch, the iteration is stopped.

A prediction loss of a noise image in a model training process is described here. The MSE loss is used to calculate a mean square error of an input noise image and an output noise prediction image. A calculation formula of the MSE loss is as follows:

$$MSE = {\sum }_{i = 1}^{n} {( {y}_{i} - {y}_{i}^{p} )}^{2} ,$$

where y is a pixel value of each point in an image, p represents a pixel of a noise prediction image, and

$${y}_{i} - {y}_{i}^{p}$$

is a different between values of pixels at the same position.

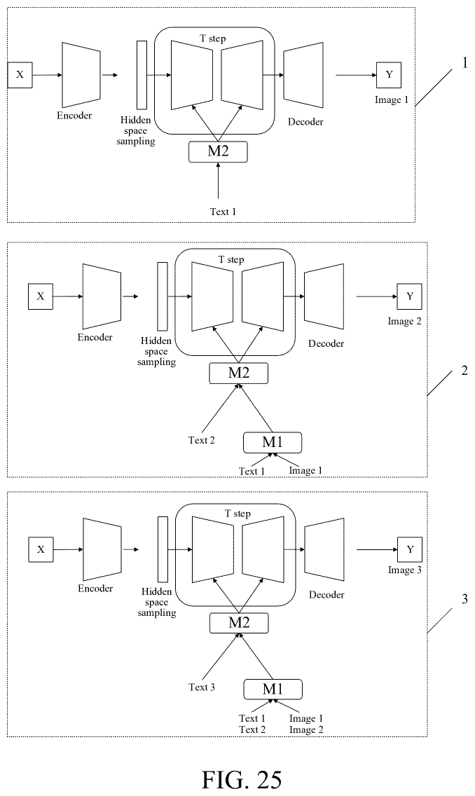

For an inference process of a consecutive frame generation model, refer to FIG. 25. FIG. 25 is a schematic diagram of an inference process of consecutive frame images according to an embodiment of this application. First, a plurality of user inputs are adapted: (1) a user enters text (namely, the description text in the foregoing descriptions) 1, and when there is no image 1, the image 1 is generated through a procedure shown by a serial number 1 in the image; (2) a user enters an image 1, and when there is no text 1, the user sets the text 1 to null; and (3) a user enters an image 1 and text 1, and does not need to perform processing. Then, input data is organized in a form of <image 1, text 1> and <image 2, text 2> shown by a serial number 2 in the image. By default, the user does not enter text, and the text 2 is null. When the user enters text at this moment, the text 2 is text entered by the user. The image 2 is generated by using a sequence model, where a noise image x0 needs to be the same as an input image in a procedure shown by the serial number 1 in the image. Next, an image 3 is generated according to a procedure shown by a serial number 3 in the image. Finally, the image 1, the image 2, and the image 3 are sequentially synthesized to obtain a target video. To simplify the process, a generation process of three consecutive frames during inferencing is described, and more frames may be continuously generated, to form a longer video.

The embodiments of this application have the following beneficial effects:
(1) Generation of an imitation of a film or television drama work can be performed on an image uploaded by the user, thereby enriching expression content of the image of the user. For example, the user uploads a smiling image, to generate a video of gradual smiling, so that information expressed by the image is richer.
(2) An image may also be animated. For example, for an illustration in a book, subsequent frame images are generated by using a model to form a short video, so that the image may be animated and changed into an animated image.
(3) A consecutive frame generation system is designed, so that the user enters an image, a new image having a style of a film or television drama work may be generated according to the image, and through a consecutive frame constraint, a sequence image is finally generated and used as a video, so that information about a previous frame and a next frame in the video is more consistent. Generation of an imitation of a film or television drama work can be performed on an image uploaded by the user, thereby enriching expression content of the image of the user. For example, the user uploads a smiling image, to generate a video of gradual smiling, so that information expressed by the image is richer.
(4) A next-frame prediction method based on the historical frame constraint is set, including how to organize historical frame information and a data process during application, to effectively disassemble a video to generate a next-frame prediction task, thereby implementing an efficient and fast image sequence generation.

The following continues to describe an exemplary structure in which a video generation apparatus 555 provided in the embodiments of this application is implemented as a software module. In some embodiments, as shown in FIG. 2, a software module stored in a video generation apparatus 555 of a memory 550 may include:
an obtaining module 5551, configured to determine the obtained initial image as the 1^{st} frame image in the frame image sequence to be generated, and obtain the description text of each frame image in the frame image sequence;
a generation module 5552, configured to iteratively generate each frame image that is in the frame image sequence and that is located after the 1^{st} frame image based on the 1^{st} frame image and the description text of each frame image in the frame image sequence; and

a synthesizing module, configured to perform video synthesis on each frame image in the frame image sequence, to obtain a target video.

In some embodiments, the generation module is further configured to generate an i^{th} frame image based on description text of an i^{th} frame image in the frame image sequence, each frame image that is in the frame image sequence and that is located before the i^{th} frame image, and description text of each frame image located before the i^{th} frame image, i being a positive integer greater than 1, and i being less than or equal to a quantity of frame images in the frame image sequence; and traverse i, to obtain each frame image in the frame image sequence.

In some embodiments, the generation module is further configured to generate text constraint information of the i^{th} frame image based on description text of the i^{th} frame image in the frame image sequence and the description text of each frame image located before the i^{th} frame image; generate image-text constraint information of the i^{th} frame image based on each frame image located before the i^{th} frame image and the description text of each frame image, both the text constraint information and the image-text constraint information being configured for constraining image content of the i^{th} frame image; fuse the text constraint information and the image-text constraint information, to obtain target constraint information; and constrain a generation process of the i^{th} frame image with reference to each frame image located before the i^{th} frame image and based on the target constraint information, to obtain the i^{th} frame image.

In some embodiments, the generation module is further configured to perform feature extraction on the description text of the i^{th} frame image in the frame image sequence and the description text of each frame image located before the i^{th} frame image respectively, to obtain a description text feature of each frame image; and obtain a first identifier feature configured for indicating a text mode, fuse the first identifier feature with the description text feature, and use a fusion result as the text constraint information of the i^{th} frame image.

In some embodiments, the generation module is further configured to perform image feature extraction on each frame image located before the i^{th} frame image, to obtain an image feature of each frame image; perform, by using the image feature of each frame image as an image constraint, text feature extraction on the description text associated with each frame image located before the i^{th} frame image, to obtain an initial image-text feature of each frame image; and obtain a second identifier feature configured for indicating an image-text mode, fuse the second identifier feature with the initial image-text feature, and use a fusion result as the image-text constraint information of the i^{th} frame image.

In some embodiments, the generation module is further configured to perform feature extraction on each frame image located before the i^{th} frame image respectively, to obtain an image feature of each frame image; perform feature fusion on the image feature of each frame image, to obtain a fusion feature; perform noise adding on the fusion feature for a first quantity of times, to obtain a noise adding fusion feature; perform denoising on the noise adding fusion feature for a second quantity of times based on the target constraint information, to obtain a denoising fusion feature; and obtain through generation the i^{th} frame image based on the denoising fusion feature.

In some embodiments, the generation module is further configured to obtain a plurality of concatenated frame image generation models, the frame image generation models being in a one-to-one correspondence with frame images other than the initial image; and perform, by using an (i−1)^{th} frame image model, prediction on the i^{th} frame image based on the description text of the i^{th} frame image in the frame image sequence, each frame image that is in the frame image sequence and that is located before the i^{th} frame image, and the description text of each frame image located before the i^{th} frame image, to obtain the i^{th} frame image.

In some embodiments, the generation module is further configured to obtain a plurality of concatenated initial frame image generation models, and obtain a reference frame image sequence including a plurality of consecutive frame image samples, the frame image samples carrying description text configured for describing a next adjacent frame image sample; use a 1^{st} frame image sample in the reference frame image sequence as a 1^{st} frame image in a target frame image sequence, and generate, by using an (i−1)^{th} initial frame image generation model, an i^{th} frame image in the target frame image sequence based on description text of an i^{th} frame image in the target frame image sequence, each frame image that is in the target frame image sequence and that is located before the i^{th} frame image, and description text of each frame image located before the i^{th} frame image, i being a positive integer greater than 1, and i being less than or equal to a quantity of frame image samples in the target frame image sequence; traverse i, to obtain through prediction each frame image in the target frame image sequence; and obtain a difference between the target frame image sequence and the reference frame image sequence, and update a model parameter of each initial frame image generation model based on the difference, to obtain the concatenated frame image generation models.

In some embodiments, the generation module is further configured to obtain a video sample and a frame extraction interval for the video sample; perform frame extraction on the video sample based on the frame extraction interval, to obtain a plurality of frame images; perform clustering on the plurality of frame images, to obtain a plurality of clusters; determine a Euclidean distance between each frame image in each cluster and a corresponding clustering center; and determine a distance threshold corresponding to each cluster, and determine, for each frame image in each cluster, a frame image whose Euclidean distance is less than a distance threshold as the frame image sample, to obtain the reference frame image sequence including the plurality of consecutive frame image samples.

In some embodiments, the generation module is further configured to perform shot division on each frame image, to obtain a plurality of sub-shots, a similarity between frame images of the sub-shots reaching a similarity threshold; select target frame images from the frame images of the sub-shots, the target frame images being capable of being configured for identifying the sub-shots; perform feature extraction on the target frame images respectively, to obtain a plurality of frame image features; and perform clustering on the plurality of frame image features, to obtain the plurality of clusters.

In some embodiments, the generation module is further configured to: for each cluster, respectively determine the Euclidean distance between each frame image in the cluster and the clustering center of the cluster; determine a maximum value of the Euclidean distance and a minimum value of the Euclidean distance from each Euclidean distance; and obtain a difference between the maximum value and the minimum value, and perform summation on a half of the difference and the minimum value, to use an obtained summation result as a distance threshold corresponding to the cluster.

In some embodiments, the synthesizing module is further configured to obtain a frame rate of the target video, the frame rate being configured for indicating a quantity of consecutive frame images played per second in the target video; and determine a ratio of a quantity of frame images in the frame image sequence to the frame rate as duration of the target video, and determine the duration as attribute information of the target video.

An embodiment of this application provides a computer program product, including computer-executable instructions. The computer program product is stored in a computer-readable storage medium. A processor of an electronic device reads the computer-executable instructions from the computer-readable storage medium, and the processor executes the computer-executable instructions, to enable the electronic device to perform the video generation method provided in this embodiment of this application.

An embodiment of this application provides a computer-readable storage medium, having computer-executable instructions stored therein, the computer-executable instructions, when executed by a processor, enabling the processor to perform the video generation method provided in this embodiment of this application. For example, the video generation method shown in FIG. 3.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM; or may be various devices including one or any combination of the foregoing memories.

In some embodiments, the computer-executable instructions may be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hyper text markup language (HTML) file, stored in a file that is specially used for a program in discussion, or stored in a plurality of collaborative files (for example, be stored in files of one or more modules, subprograms, or code parts).

As an example, the computer-executable instructions may be deployed on one electronic device for execution, or executed on a plurality of electronic devices located at one location, or executed on a plurality of electronic devices distributed at a plurality of locations and interconnected by using a communication network.

In conclusion, the embodiments of this application have the following beneficial effects: When each frame image in the frame image sequence to be generated is generated, a generation process of each frame image is constrained by using each frame image located before the frame image and the description text associated with each frame image located before the frame image as target constraint information. Accordingly, the content of a generated frame image can be consistent with content of each frame image located before the frame image. In addition, the frame image generation model is obtained through training by using a video sample having a film or television drama style. A plurality of consecutive frame images having a corresponding film or television drama style may be generated from one initial image, to generate a target video having the film or television drama style. Accordingly, generation of an imitation of a film or television drama work can be performed on an image, thereby enriching expression content of the image. In addition, in the method for performing prediction on the current frame image based on generated constraint information corresponding to a frame image located before the current frame image, so that a video generation process can be disassembled into a prediction task of a next frame image, thereby implementing efficient and fast generation of consecutive frame images.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A video generation method, performed by an electronic device, the method comprising:
obtaining an initial image, and obtaining a plurality of pieces of description text, each piece of description text describing a frame image in a frame image sequence to be generated;
iteratively generating, by using the initial image as a 1^{st} frame image and based on the 1^{st} frame image and the plurality of pieces of description text, at least one frame image located after the 1^{st} frame image, to obtain a frame image sequence comprising the 1^{st} frame image and the at least one frame image; and
performing video synthesis on each frame image in the frame image sequence, to obtain a target video.

2. The method according to claim 1, wherein the iteratively generating, by using the initial image as a 1^{st} frame image and based on the 1^{st} frame image and the plurality of pieces of description text, at least one frame image located after the 1^{st} frame image comprises:
generating an i^{th} frame image based on the 1^{st} frame image, each frame image that is in the frame image sequence and that is located before the i^{th} frame image, and a description text of each frame image located before the i^{th} frame image, i being a positive integer greater than 1 and less than or equal to a preset quantity; and
traversing i, to obtain each frame image that is in the frame image sequence and that is located after the 1^{st} frame image.

3. The method according to claim 2, wherein the generating an i^{th} frame image based on the 1^{st} frame image, each frame image that is in the frame image sequence and that is located before the i^{th} frame image, and description text of each frame image located before the i^{th} frame image comprises:
generating text constraint information of the i^{th} frame image based on description text of the i^{th} frame image in the frame image sequence and the description text of each frame image located before the i^{th} frame image;
generating image-text constraint information of the i^{th} frame image based on each frame image that comprises the 1^{st} frame image and that is located before the i^{th} frame image and the description text of each frame image, both the text constraint information and the image-text constraint information being constraining of image content of the i^{th} frame image;
fusing the text constraint information and the image-text constraint information to obtain target constraint information; and
generating the i^{th} frame image based on the target constraint information.

4. The method according to claim 3, wherein the generating text constraint information of the i^{th} frame image based on description text of the i^{th} frame image in the frame image sequence and the description text of each frame image located before the i^{th} frame image comprises:
performing feature extraction on the description text of the i^{th} frame image in the frame image sequence and the description text of each frame image located before the i^{th} frame image respectively, to obtain a description text feature of each frame image; and
obtaining a first identifier feature indicating a text mode, fusing the first identifier feature with the description text feature, and using a fusion result as the text constraint information of the i^{th} frame image.

5. The method according to claim 3, wherein the generating image-text constraint information of the i^{th} frame image based on each frame image that comprises the 1^{st} frame image and that is located before the i^{th} frame image and the description text of each frame image comprises:
performing image feature extraction on each frame image located before the i^{th} frame image, to obtain an image feature of each frame image;
performing, by using the image feature of each frame image as an image constraint, text feature extraction on the description text associated with each frame image located before the i^{th} frame image, to obtain an initial image-text feature of each frame image; and
obtaining a second identifier feature indicating an image-text mode, fusing the second identifier feature with the initial image-text feature, and using a fusion result as the image-text constraint information of the i^{th} frame image.

6. The method according to claim 3, wherein the generating the i^{th} frame image based on the target constraint information comprises:
performing feature extraction on each frame image located before the i^{th} frame image respectively, to obtain an image feature of each frame image;
performing feature fusion on the image feature of each frame image, to obtain a fusion feature;
performing noise adding on the fusion feature for a first quantity of times, to obtain a noise adding fusion feature;
performing denoising on the noise adding fusion feature for a second quantity of times based on the target constraint information, to obtain a denoising fusion feature; and
obtaining through generation the i^{th} frame image based on the denoising fusion feature.

7. The method according to claim 2, wherein the generating an i^{th} frame image based on the 1^{st} frame image, the plurality of pieces of description text, each frame image that is in the frame image sequence and that is located before the i^{th} frame image, and description text of each frame image located before the i^{th} frame image comprises:
obtaining a frame image generation model sequence, the frame image generation model sequence comprising a plurality of concatenated frame image generation models, and the frame image generation model being in a one-to-one correspondence with another frame image other than the 1^{st} frame image; and
performing, by using an (i−1)^{th} frame image model, prediction on the i^{th} frame image based on the description text of the i^{th} frame image in the frame image sequence, each frame image that is in the frame image sequence and that is located before the i^{th} frame image, and the description text of each frame image located before the i^{th} frame image, to obtain the i^{th} frame image.

8. The method according to claim 7, wherein before the obtaining a frame image generation model sequence, the method further comprises:
obtaining a plurality of concatenated initial frame image generation models, and obtaining a reference frame image sequence comprising a plurality of consecutive frame image samples, the frame image samples carrying description text describing a next adjacent frame image sample;
using a 1^{st} frame image sample in the reference frame image sequence as a 1^{st} frame image in a target frame image sequence, and generating, by using an (i−1)^{th} initial frame image generation model, an i^{th} frame image in the target frame image sequence based on description text of an i^{th} frame image in the target frame image sequence, each frame image that is in the target frame image sequence and that is located before the i^{th} frame image, and description text of each frame image located before the i^{th} frame image,
i being a positive integer greater than 1, and i being less than or equal to a quantity of frame image samples in the target frame image sequence;
traversing i, to obtain through prediction each frame image in the target frame image sequence; and
obtaining a difference between the target frame image sequence and the reference frame image sequence, and updating a model parameter of each initial frame image generation model based on the difference, to obtain the frame image generation model sequence.

9. The method according to claim 8, wherein the obtaining a reference frame image sequence comprising a plurality of consecutive frame image samples comprises:
obtaining a video sample and a frame extraction interval for the video sample;
performing frame extraction on the video sample based on the frame extraction interval, to obtain a plurality of frame images;
performing clustering on the plurality of frame images, to obtain a plurality of clusters;
determining a Euclidean distance between each frame image in each cluster and a corresponding clustering center; and
determining, for each frame image in each cluster, a frame image whose Euclidean distance is less than a distance threshold as the frame image sample, to obtain the reference frame image sequence comprising the plurality of consecutive frame image samples.

10. The method according to claim 9, wherein the performing clustering on the plurality of frame images, to obtain a plurality of clusters comprises:
performing shot division on each frame image, to obtain a plurality of sub-shots, a similarity between frame images of the sub-shots reaching a similarity threshold;
selecting target frame images from the frame images of the sub-shots, the target frame images being configured for identifying the sub-shots;
performing feature extraction on the target frame images respectively, to obtain a plurality of frame image features; and
performing clustering on the plurality of frame image features, to obtain the plurality of clusters.

11. The method according to claim 9, wherein before the determining, for each frame image in each cluster, a frame image whose Euclidean distance is less than a distance threshold as the frame image sample, the method further comprises:
for each cluster, respectively determining the Euclidean distance between each frame image in the cluster and the clustering center of the cluster;
determining a maximum value of the Euclidean distance and a minimum value of the Euclidean distance from each Euclidean distance; and
obtaining a difference between the maximum value and the minimum value, and performing summation on a half of the difference and the minimum value, to use an obtained summation result as a distance threshold corresponding to the cluster.

12. The method according to claim 1, wherein after the performing video synthesis on each frame image in the frame image sequence, to obtain a target video, the method further comprises:
obtaining a frame rate of the target video, the frame rate indicating a quantity of consecutive frame images played per second in the target video; and
determining a ratio of a quantity of frame images in the frame image sequence to the frame rate as duration of the target video, and determining the duration as attribute information of the target video.

13. An electronic device, comprising:
a memory, configured to store executable instructions; and
a processor, configured to implement a video generation method, performed by an electronic device, the method comprising:
obtaining an initial image, and obtaining a plurality of pieces of description text, each piece of description text describing a frame image in a frame image sequence to be generated;
iteratively generating, by using the initial image as a 1^{st} frame image and based on the 1^{st} frame image and the plurality of pieces of description text, at least one frame image located after the 1^{st} frame image, to obtain a frame image sequence comprising the 1^{st} frame image and the at least one frame image; and
performing video synthesis on each frame image in the frame image sequence, to obtain a target video.

14. The electronic device according to claim 13, wherein the iteratively generating, by using the initial image as a 1^{st} frame image and based on the 1^{st} frame image and the plurality of pieces of description text, at least one frame image located after the 1^{st} frame image comprises:
generating an i^{th} frame image based on the 1^{st} frame image, each frame image that is in the frame image sequence and that is located before the i^{th} frame image, and a description text of each frame image located before the i^{th} frame image, i being a positive integer greater than 1 and less than or equal to a preset quantity; and
traversing i, to obtain each frame image that is in the frame image sequence and that is located after the 1^{st} frame image.

15. The electronic device according to claim 14, wherein the generating an i^{th} frame image based on the 1^{st} frame image, each frame image that is in the frame image sequence and that is located before the i^{th} frame image, and description text of each frame image located before the i^{th} frame image comprises:
generating text constraint information of the i^{th} frame image based on description text of the i^{th} frame image in the frame image sequence and the description text of each frame image located before the i^{th} frame image;
generating image-text constraint information of the i^{th} frame image based on each frame image that comprises the 1^{st} frame image and that is located before the i^{th} frame image and the description text of each frame image, both the text constraint information and the image-text constraint information being constraining of image content of the i^{th} frame image;
fusing the text constraint information and the image-text constraint information to obtain target constraint information; and
generating the i^{th} frame image based on the target constraint information.

16. The electronic device according to claim 15, wherein the generating text constraint information of the i^{th} frame image based on description text of the i^{th} frame image in the frame image sequence and the description text of each frame image located before the i^{th} frame image comprises:
performing feature extraction on the description text of the i^{th} frame image in the frame image sequence and the description text of each frame image located before the i^{th} frame image respectively, to obtain a description text feature of each frame image; and
obtaining a first identifier feature indicating a text mode, fusing the first identifier feature with the description text feature, and using a fusion result as the text constraint information of the i^{th} frame image.

17. A non-transitory computer-readable storage medium, storing computer-executable instructions, the computer-executable instructions, when executed by a processor, implementing a video generation method, performed by an electronic device, the method comprising:
obtaining an initial image, and obtaining a plurality of pieces of description text, each piece of description text describing a frame image in a frame image sequence to be generated;
iteratively generating, by using the initial image as a 1^{st} frame image and based on the 1^{st} frame image and the plurality of pieces of description text, at least one frame image located after the 1^{st} frame image, to obtain a frame image sequence comprising the 1^{st} frame image and the at least one frame image; and
performing video synthesis on each frame image in the frame image sequence, to obtain a target video.

18. The computer-readable storage medium according to claim 17, wherein the iteratively generating, by using the initial image as a 1^{st} frame image and based on the 1^{st} frame image and the plurality of pieces of description text, at least one frame image located after the 1^{st} frame image comprises:
generating an i^{th} frame image based on the 1^{st} frame image, each frame image that is in the frame image sequence and that is located before the i^{th} frame image, and a description text of each frame image located before the i^{th} frame image, i being a positive integer greater than 1 and less than or equal to a preset quantity; and
traversing i, to obtain each frame image that is in the frame image sequence and that is located after the 1^{st} frame image.

19. The computer-readable storage medium according to claim 18, wherein the generating an i^{th} frame image based on the 1^{st} frame image, the plurality of pieces of description text, each frame image that is in the frame image sequence and that is located before the i^{th} frame image, and description text of each frame image located before the i^{th} frame image comprises:
obtaining a frame image generation model sequence, the frame image generation model sequence comprising a plurality of concatenated frame image generation models, and the frame image generation model being in a one-to-one correspondence with another frame image other than the 1^{st} frame image; and
performing, by using an (i−1)^{th} frame image model, prediction on the i^{th} frame image based on the description text of the i^{th} frame image in the frame image sequence, each frame image that is in the frame image sequence and that is located before the i^{th} frame image, and the description text of each frame image located before the i^{th} frame image, to obtain the i^{th} frame image.

20. The computer-readable storage medium according to claim 19, wherein before the obtaining a frame image generation model sequence, the method further comprises:
obtaining a plurality of concatenated initial frame image generation models, and obtaining a reference frame image sequence comprising a plurality of consecutive frame image samples, the frame image samples carrying description text describing a next adjacent frame image sample;
using a 1^{st} frame image sample in the reference frame image sequence as a 1^{st} frame image in a target frame image sequence, and generating, by using an (i−1)^{th} initial frame image generation model, an i^{th} frame image in the target frame image sequence based on description text of an i^{th} frame image in the target frame image sequence, each frame image that is in the target frame image sequence and that is located before the i^{th} frame image, and description text of each frame image located before the i^{th} frame image,
i being a positive integer greater than 1 and less than or equal to a quantity of frame image samples in the target frame image sequence;
traversing i, to obtain through prediction each frame image in the target frame image sequence; and
obtaining a difference between the target frame image sequence and the reference frame image sequence, and updating a model parameter of each initial frame image generation model based on the difference, to obtain the frame image generation model sequence.
